(19) United States
(12) Patent Application Publication
(10) Pub. No.: US 2004/0012627 A1
(43) Pub. Date: Jan. 22, 2004

(54) Configurable browser for adapting content to diverse display types

(76) Inventors: Sany Zakharia, Helsinki (FI); Niko Eiden, Helsinki (FI)

Correspondence Address: CRAWFORD PLLC, Suite 390, 1270 Northland Drive, St. Paul, MN, 55120, US

(21) Appl. No.: 10/197,228

(22) Filed: Jul. 17, 2002

(51) Int. Cl. G09G 5/00

(52) U.S. Cl. 345/744; 345/853

(57) ABSTRACT

A system, apparatus, and method for rendering content on electronic devices having a display. Content having first format characteristics is received at an electronic device. Based on the particular first format characteristics of the received content, one or more rendering rules are invoked. The content is rendered according to the invoked rules, where the resulting rendered content has second format characteristics. The content as rendered is displayed on the display of the electronic device.

### FIELD OF THE INVENTION

This invention relates in general to content browser applications, and more particularly to a system, method, and apparatus for automatically adapting and rendering content on displays having display characteristics that otherwise do not facilitate rendering in the original size and manner in which the content is provided.

### BACKGROUND OF THE INVENTION

Both landline and wireless computing systems are presently capable of receiving information in a variety of content types and formats, from a variety of different sources including networked sources. Landline systems, such as desktop computers, workstations, terminals, etc. generally utilize commercially-available Web browsers in order to interact with various kinds of Internet resources. This type of browser is generally a software program stored locally at the client device. In the Internet context, web content created with Hypertext Markup Language (HTML) or other language can be read by such Web browsers.

Analogous technologies exist for communicating landline content via wireless devices. For example, one such technology facilitating the transfer of Internet content to and from wireless devices is the Wireless Application Protocol (WAP), which integrates the Internet and other networks with wireless network platforms. Generally, WAP is a set of protocols that accounts for characteristics and functionality of both Internet standards and standards for wireless services. It is generally independent of wireless network standards, and is designed as an open standard. WAP bridges the gap between the wireline Internet paradigm and the wireless domain, to allow wireless device users to enjoy the benefits of the Internet across both platforms. Other current and anticipated technologies are also used or contemplated for use in communicating content to and from wireless devices. In order to view or otherwise consume such Internet content via wireless devices using WAP, a WAP browser may be utilized. Other analogous browsers may be used for different wireless protocols.

Content from the Internet or other networked sources will be increasingly consumed on smaller devices. For example, the popularity and resulting proliferation of portable and hand-held wireless devices has confirmed the need to make Internet web pages and other content available to mobile device users. However, there are various factors that limit the ability of a user to efficiently consume Internet content via mobile terminals. One such factor is the relatively limited display capabilities on mobile terminals, due to the limited display screen size.

The small displays and reduced usability of mobile terminals make the consumption of Internet content challenging, as Internet content is typically designed and formatted for consumption on desktop or other wireline platforms used with high-resolution displays and advanced input capabilities. Because a mobile device's display is smaller and often has a much lower resolution than that of larger desktop systems, Internet content is scaled down when rendered onto the smaller display screens. Thus, a page with many elements, including images, text, links, banners, frames, etc., will generally be scaled down such that the elements and the spacing therebetween will be significantly reduced when rendered onto the smaller display. Thus, the display screen may appear cluttered with elements that are difficult to view or even distinguish from one another. Alternatively, the elements on the page may not be fully scaled down, but the extent in which a user must scroll to see the entire page may be unduly burdensome.

Accordingly, there is a need in the communications industry for a manner of adapting and rendering content for use on displays having characteristics different from the displays for which the content was originally designed. The present invention fulfills these and other needs, and offers other advantages over the prior art approaches.

### SUMMARY OF THE INVENTION

In accordance with one embodiment of the invention, a method is provided for rendering content on electronic devices having a display. Content having first format characteristics is received at an electronic device. Based on the particular first format characteristics of the received content, one or more rendering rules are invoked. The content is rendered according to the invoked rules, where the resulting rendered content has second format characteristics. The content as rendered is displayed on the display of the electronic device.

In accordance with more particular embodiments of such a method, a plurality of selectable rendering modes are provided, where each of the selectable rendering modes is associated with a different set of the rendering rules. The rendering modes may be user-definable, and/or provided by a service provider, network operator, or other content provider.

In other specific embodiments of such a method, multiple rendering rules are invoked, the content is rendered according to a collective directive of the plurality of rendering rules.

In another specific embodiment of this method, a plurality of the rendering rules are arranged as a feature for selection by the user, where the feature is presented to the user to select attributes for the rendering rules associated with the feature.

Another specific embodiment of the method includes associating a bookmarked address with one or more of the rendering rules, selecting the bookmarked address to launch the content available via the bookmarked address, and rendering the content according to the rendering rules associated with the bookmarked address. The second bookmarked addressed that have characteristics corresponding to at least one previously bookmarked address may be automatically identified, and the second bookmarked addresses may then be associated with the rendering rules associated with the previously bookmarked address.

In another particular embodiment of the method, rendering the content according to the invoked rules involves rendering links associated with the content having the first format characteristics to links associated with the content having the second format characteristics; for example, rendering links to a larger size or having different link text.

In another particular embodiment, the method includes emphasizing elements associated with the rendered content when displayed on the electronic device, such as by highlighting the elements with a color. Rendering rules may then be applied to the emphasized elements when they are selected, where these rules provide a wide range of viewing options for these elements.

Another embodiment of the method involves rendering tables according to the invoked rules by selectively parsing the table row-by-column or column-by-row. The user may be afforded an opportunity to make such a selection, or such parsing may be automatically selected based on predetermined parameters.

In accordance with another embodiment of the invention, an electronic apparatus is provided for presenting content received via a network. The apparatus includes a memory to store rendering rules, and a processor coupled to the memory to receive the rendering rules. The processor is configured to invoke one or more of the rendering rules based on first format characteristics of the received content, and to render the content according to the invoked rules to provide rendered content having second format characteristics. A display device then displays the rendered content.

In accordance with another embodiment of the invention, a system is provided for transmitting electronic content via a network for viewing by electronic device users. The system includes a source computing system for transmitting the content via the network, where the transmitted content has first format characteristics associated therewith. The system also includes at least one electronic device coupled to receive the transmitted content from the source computing system via the network. The electronic device includes a memory to store a plurality of rendering rules, and a processor coupled to the memory to receive the rendering rules. The processor is configured to invoke one or more of the rendering rules based on the first format characteristics of the transmitted content, and to render the transmitted content according to the invoked rules to provide rendered content having second format characteristics. The electronic device further includes a display device to display the rendered content.

### BRIEF DESCRIPTION OF THE DRAWINGS

The invention is described in connection with the embodiments illustrated in the following diagrams.

FIG. 1 is a block diagram of a representative networking environment in which the principles of the present invention may be applied;

FIG. 2 is a block diagram illustrating a conceptual smart browser in accordance with the principles of the present invention;

FIG. 3 is a representative example of one manner in which the smart browser can be used to adapt content for rendering on a particular device in accordance with the present invention;

FIG. 4 illustrates an example of a menu portion from which smart browser modes may be selected;

FIG. 5 illustrates an exemplary feature for rendering large images in accordance with one embodiment of the present invention;

FIG. 6 is a flow diagram of an exemplary manner of locally rendering content for presentation on a local device in accordance with one embodiment of the present invention;

FIG. 7 is a flow diagram of another exemplary embodiment for locally rendering content for presentation on a local device in accordance with the present invention;

FIG. 8 illustrates an exemplary feature for providing an intelligent bookmarking feature in accordance with the present invention;

FIG. 9 illustrates exemplary embodiments for rendering links on small displays using a smart hotspot feature in accordance with the principles of the present invention;

FIG. 10 illustrates rules and attributes associated with an exemplary smart hotspots feature in accordance with the principles of the present invention;

FIG. 11 is a flow diagram illustrating an exemplary method for employing a hotspots feature in accordance with the present invention;

FIG. 12 illustrates an exemplary user interface in which smart element control may be configured in accordance with one embodiment of the invention;

FIGS. 13A-13F provide representative examples of how an action is applied to one or more elements utilizing the smart element control features in accordance with the invention;

FIG. 14 illustrates a representative Internet web page designed using tables;

FIG. 15A illustrates the potentially undesirable result of parsing a web page table row by column and rendering onto a narrow display;

FIG. 15B illustrates how a web page table may be parsed and rendered in a more intelligible manner utilizing a smart table features in accordance with the present invention;

FIGS. 16A, 16B, and 16C further illustrate the manner in which the smart table feature may be used to provide the user with display options in which to render and present tables; and

FIG. 17 illustrates a representative mobile terminal computing system capable of carrying out operations in accordance with the present invention.

### DETAILED DESCRIPTION OF THE INVENTION

In the following description of the exemplary embodiment, reference is made to the accompanying drawings which form a part hereof, and in which is shown by way of illustration various manners in which the invention may be practiced. It is to be understood that other embodiments may be utilized, as structural and operational changes may be made without departing from the scope of the present invention.

Generally, the present invention provides a browser application to facilitate the rendering of content, such as Internet content, on a wide range of display types. For example, Internet content is generally designed for consumption on standard, full-size monitors or other display screens. The present invention provides a rule-based browser that automatically adapts the content for presentation on displays having sizes and/or other display characteristics different than the full-size monitors for which the content was originally intended. This “smart browser” in accordance with the present invention is configurable and modular, and can be configured in order to suit any device type and content type.

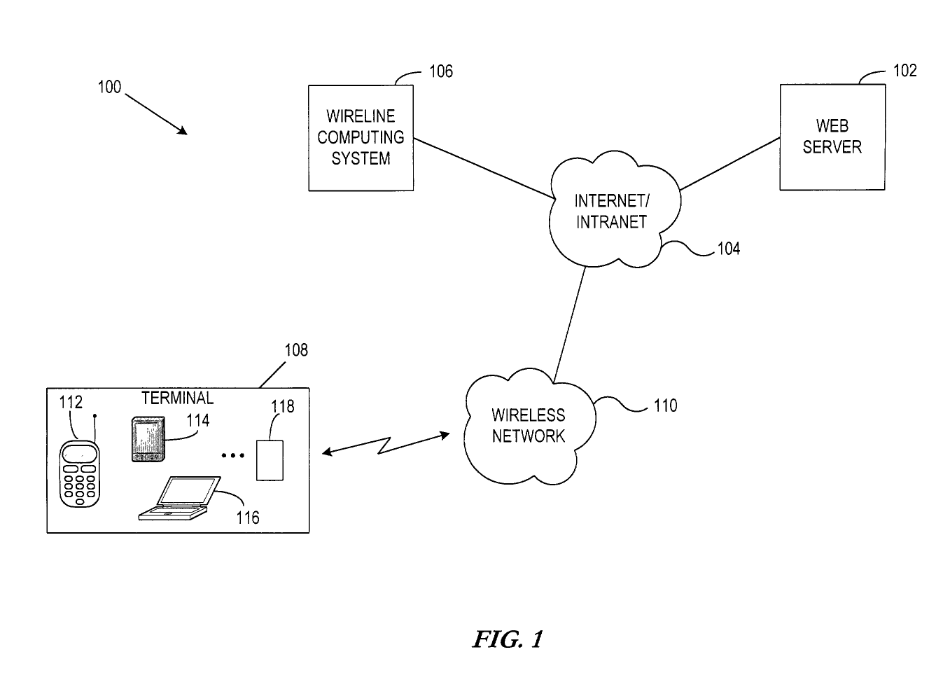

FIG. 1 is a block diagram of a representative networking environment 100 in which the principles of the present invention may be applied. The present invention is applicable in any environment where client or other communication devices receive (and transmit) information, such as via a direct connection or via landline and/or mobile networks. The simplified networking environment 100 of FIG. 1 is provided for purposes of facilitating an understanding of a system in which the present invention is particularly useful, however it will become apparent to those skilled in the art from the description provided herein that the present invention is applicable in a wide variety of situations where computer “browsing” functionality is employed.

Both landline (also referred to as “wireline”) and wireless computing systems are presently capable of receiving information in a variety of content types and formats. Landline systems, such as desktop computers, workstations, terminals, etc. generally utilize commercially-available Web browsers in order to interact with various kinds of Internet resources. Such a browser is a software program, generally stored locally at the client device. In the Internet context, web content created with Hypertext Markup Language (HTML) or other language can be read by such Web browsers. Analogous technologies exist for communicating landline content via wireless devices. For example, one such technology facilitating the transfer of Internet content to and from wireless devices is the Wireless Application Protocol (WAP), which integrates the Internet and other networks with wireless network platforms. Generally, WAP is a set of protocols that accounts for characteristics and functionality of both Internet standards and standards for wireless services. It is generally independent of wireless network standards, and is designed as an open standard. WAP bridges the gap between the wireline Internet paradigm and the wireless domain, to allow wireless device users to enjoy the benefits of the Internet across both platforms. Other current and anticipated technologies are also used or contemplated for use in communicating content to and from wireless devices.

One problem facing the telecommunications industry relates to content rendering on mobile devices, where the content was originally intended for rendering on a system such as a workstation or desktop computer. Some of the inherent and desirable characteristics of handheld or other portable terminals, including their relatively small size, presents a dilemma when attempting to render content on a mobile terminal display that may be significantly smaller than their desktop counterparts. For example, a web server 102 may provide content via an intranet or the Internet 104 that is provided to a client computer or other wireline computing system 106. The content may be provided with the intention of being viewed by such a wireline computing system 106, which generally includes a display large enough so that the content can be appropriately rendered on its display. While this is not always the case, as wireline computing systems 106 may also be unable to render the content in an appropriate manner, larger wireline computing systems 106 often include suitable rendering means.

The problem is more prevalent, however, where Internet content provided by a web server 102 or other content source is ultimately provided to a mobile terminal 108 via one or more wireless networks 110. The mobile terminal 108 may include any type of wireless device, such as a cellular/mobile telephone 112, a personal digital assistant (PDA) 114, a notebook or laptop computer 116, or any other type of terminal represented by device 118. For such devices, the display elements are generally smaller and have lower resolutions than that of a landline computer. In order for such display elements to display the Internet content, the content must be scaled down when rendered onto the smaller mobile device screen. It can be difficult for users to manipulate the device to view a large and/or complex page with many components. Because of the many different types of content, content formats, and the many different types, sizes, manufacturers, etc. of mobile and landline devices, it is difficult for content providers to adapt the Internet content to adequately suit each of these different current and future classes of devices. The present invention provides a solution to this problem by addressing this inherent rendering incompatibility at the receiving end of the content transfer, through the use of a highly configurable and modular smart browser that can be fully configured in order to suit any type of device and content.

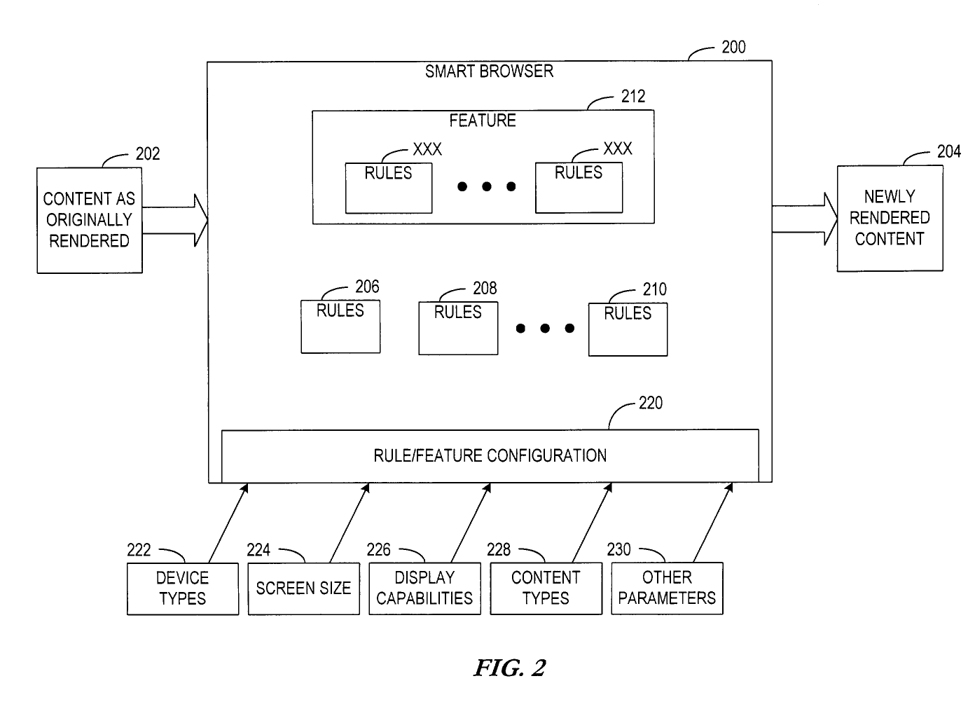

FIG. 2 is a block diagram illustrating a conceptual “smart browser” 200 in accordance with the principles of the present invention. The content as originally rendered, shown at block 202 is in a first format, including, for example, a format best suited for particular device types or screen sizes having certain display characteristics. This content 202 may also exhibit one or more content types, such as text, images or other graphics, video, tables, and the like.

One or more computing devices may be coupled in a manner to receive the content 202. For example, a computer may be coupled via one or more networks, such as an intranet(s) and/or other networks such as the Internet. Other devices that may be coupled to receive the content 202 include a variety of current and future mobile devices wirelessly coupled to receive the content 202 via one or more wireless networks which may in turn be coupled to landline networks such as the Internet. In accordance with the present invention, it is often desirable for these content-receiving computing devices and mobile terminals to receive the content in a format better suited for the particular receiving device. Using the smart browser 200 in accordance with the present invention, the content 202 as originally rendered is configured to provide the newly rendered content 204, which is better suited for the particular device and/or application in which the content is being utilized.

In accordance with the present invention, a variety of different parameters may affect the manner in which the smart browser 200 configures the content 202 to provide the newly rendered content 204. Examples of such parameters are described more fully below. Based on the desired configuration, the smart browser 200 applies rules, for example one or more of rules 206, 208, . . . 210, to the incoming content 202 to reconfigure the content in a manner better suited for presentation on a receiving device such as a mobile terminal. From a rendering perspective, the smart browser 200 includes at least one, but often many such rules. In accordance with one embodiment of the invention, these rules correspond to a distinct functionality, where such functionality may include a single operation or a plurality of operations.

Using Internet content as an example, smart browser 200 rules are applied to Internet content 202 in order to control the manner in which it is rendered onto, for example, a mobile terminal's display. One or more individual rules 206, 208, . . . 210 may be activated to perform certain functions, while other existing rules may remain inactivated in a particular situation. In this manner, the smart browser 200 can be optimally “tuned” to the particular Internet content 202, the specific device display size and characteristics, and/or to the user's desires through the activation of one or a combination of rules.

Rule functions may range from being mutually exclusive to being complementary. For example, one rule 206 may perform a function that is opposite or otherwise different to the function associated with another rule 208. On the other hand, complementary rules can be associated with each other and organized into “features.” An example of such a collection of complementary rules, i.e., a feature, is illustrated as the feature 212 in FIG. 2. In this example, a number of complementary rules 214 through 216 are associated with the feature 212, such that when the feature 212 is activated, each of the rules 214, 216 associated with the feature 212 will be applied to at least a portion of the content 202. Such features 212 provide a unique functionality, and are thus an abstraction of various rules themselves. The functionality of such conceptual features 212 can be configured through the rules 214, 216 associated therewith.

The smart browser 200 may be configured to adapt content to the particular device and/or implementation in which the content is to be presented. The user, and/or a manufacturer, service provider, etc., may configure the rules and features associated with the smart browser 200. The ability to configure such rules and features is depicted by the rule/feature configuration module 220. Such a module 220 may include a software module that activates certain rules (e.g., 206, 208, 210) and/or features (e.g., 212) for certain types of incoming content 202. In one embodiment, the user can perform such configuration, such as via a user interface on the mobile terminal that provides the interface to the configuration module 220. In another embodiment, one or more rules and/or features may be pre-configured by a device manufacturer, or may be provided over-the-air (OTA) or via a landline connection from a service provider, network operator, or other content provider.

Whether configured by the user or other entity, a number of parameters may be considered when configuring the smart browser 200. One such parameter is the device type 222 may affect the decision to create and/or activate a particular rule(s) or feature(s). For example, for a particular manufacturer and model of mobile telephone, certain rules may be created and/or activated to properly present Internet content 202 on that mobile telephone. Another representative parameter is the screen size 224 of the device. For example, the screen size of a portable laptop computer may be larger than the screen size on a mobile telephone or Personal Digital Assistant (PDA), in which case these parameters can be taken into account when creating and/or configuring rules and features. Another parameter may be the display capabilities 226 of the device. For example, display screens having a relatively low display resolution may implement additional rules or features that may not be required for higher resolution displays. Still another parameter to be considered in creating and/or configuring rules and features is the type 228 of content expected to be received on the device. For example, if the expected or typical content type 228 to be received on a mobile terminal is graphics or images, certain rules may be created and/or activated that may not be necessary for terminals expecting to predominantly receive text. These, as well as a wide variety of other parameters 230, may be considered in connection with the creation and configuration of rules/features and in connection with the overall configuration of the smart browser 200.

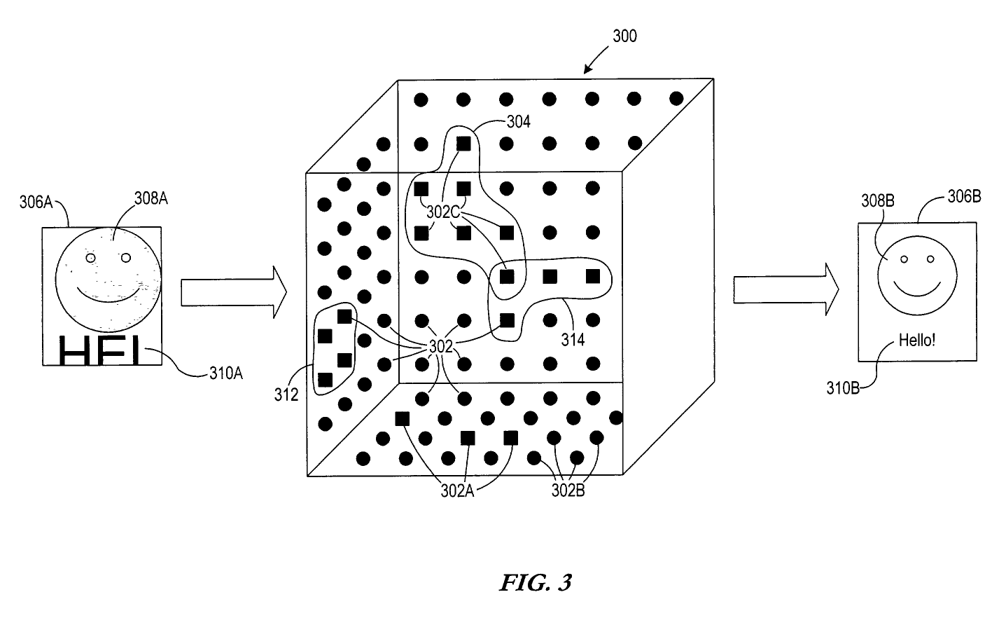

FIG. 3 is a representative example of one manner in which the smart browser can be used to adapt content for rendering on a particular device in accordance with the present invention. In this embodiment, the smart browser 300 is depicted as a collection of rules 302. Any one or more of these rules 302 may be activated and applied to incoming content. For purposes of illustration, activated rules are depicted as squares, while inactivated rules are depicted as circles. For example, rules 302 represent all of the rules associated with the smart browser 300, while rules 302A represent a few of the activated rules, and rules 302B represent a few inactivated rules.

More than one rule may be combined through multiple selections, in order to create more powerful rendering combinations. In one embodiment of the invention, a number of activated rules 302C may be associated with each other to create a feature, depicted by the group 304 of rules 302C.

Content block 306A represents content, such as Internet content, that is to be presented on a device, such as a mobile terminal. In this example, at least one image 308A and at least one text block 310A is provided, which would appear in a first format as shown in block 306A prior to being subjected to the activated rules and/or features of the smart browser 300. In this first format, the image 308A may be a first size, color, or other attribute. Similarly, the text 310A may be a first size, font, color, etc. When the activated rules 302A and/or features 304 are applied to the content 306A, the content is adapted for use on the mobile terminal, as depicted by content block 306B. The newly rendered content 306B includes, for example, an image 308B, and text 310B. The activated rules and/or features associated with the smart browser 300 cause the image 308B and/or text 310B to be rendered differently than in the original content 306A format. For example, the image may be reduced in size, changed in color and/or resolution, and the like. The text 310B as newly rendered may similarly be changed, such as reduced in size and changed to a font more suitable for the display characteristics of the particular mobile terminal. In the particular example of FIG. 3, the user would be relieved of the burden of having to scroll or otherwise view limited portions of the image and text as originally presented, by changing these characteristics via the smart browser 300. The example of FIG. 3 represents just one manner in which the activated rules and features of the smart browser 300 can be used to render content on a receiving device in a fashion better suited for that receiving device.

The smart browser 300 provides for multiple modes of operation. In one embodiment of the invention, at least one of these modes is a default mode. Such a default mode may be a factory present mode or other pre-configured mode specially adapted for a particular device manufacturer, display type, display size, content type, etc. Such a mode may be preset during a device manufacturing process, or alternatively may subsequently be made available to users. Other embodiments include one or more user-defined modes, where the mobile terminal user creates a mode where the rules and/or features associated with such a mode can be selected as a group.

In accordance with the invention, a “mode” as described above generally refers to a particular setting of rules on the smart browser 300. In accordance with one embodiment of the invention, the same rules provide the basis for each of the operational modes, but different rules may be associated with different modes. Thus, in accordance with one embodiment, modes are differentiated by the particular settings of the same set of rules. For example, a first group of activated rules may represent a first mode 312, while a second group of activated rules may represent a second mode 314. Modes may have rules common to other modes. For example, assuming that the previously-described feature 304 were defined as a mode, mode 304 and mode 314 have at least one activated rule common to both. Theoretically, each of two (or more) different modes could have all of their respective activated rules common to the other mode, although each mode would produce the same results.

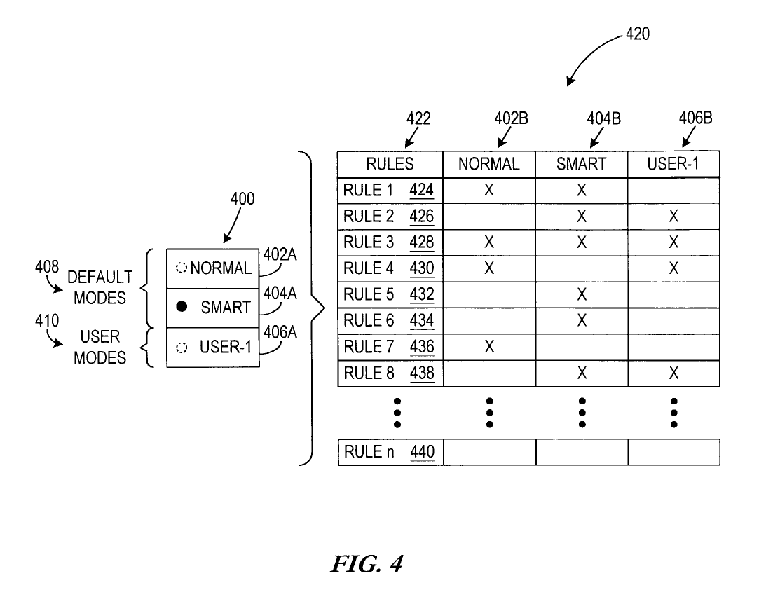

In accordance with one embodiment of the invention, the user can switch between modes supported by the smart browser associated with the particular device. This can be effected using, for example, a user interface on the device. For example, the device may be a mobile terminal having user interface elements including a keypad or other user-entry mechanism, a display supporting a textual and/or graphical user interface (GUI), audio interface including a speaker and microphone, etc. One particular user interface may be a graphical and/or textual menu having selectable items associated therewith. FIG. 4 illustrates an example of a menu portion from which smart browser modes may be selected.

In the example of FIG. 4, menu portion 400 is shown, which represents at least a portion of a device's menu. The illustrated portion of the menu 400 includes multiple mode options, including a normal mode 402A, smart mode 404A, and at least one user-defined mode, user-1 406A. In the illustrated embodiment, the normal mode 402A and smart mode 404A represent default modes 408, such that they are provided as pre-configured modes by the device manufacturer, network operator, content provider, etc. On the other hand, the user-1 mode 406A is a user mode 410, that may be created, modified, and otherwise maintained by the user of the device. Any number of such user-defined modes may be created in accordance with the present invention.

The user can then select the desired mode 402A, 404A, 406A using any desired or available user interface mechanism. Thus, the user can select the desired mode using any number of known user interface methods, including a graphical or textual user interface, push-button selection, audio commands, text entry, etc. In the illustrated embodiment, a menu-based user interface is utilized, and the smart mode 404A has been selected.

As previously indicated, each of the representative modes 402A, 404A, 406A is associated with a certain set of rules. This is depicted by the table 420, where each of the modes 402A, 404A, 406A available on the menu 400 is defined by corresponding rules. For example, the table 420 includes some or all of the rules 422 associated with the smart browser. Each of the available modes are illustrated in connection with this table 420, including the normal mode 402B, 404B, 406B. It should be noted that the table 420 is provided for purposes of facilitating the description of this embodiment of the invention, and is not intended to represent any particular data structure in which this information may be stored on the mobile terminal.

The rules 422 include a list of at least a portion, or all of the rules available by way of the smart browser. These rules are illustrated as rule-1 424, rule-2 426, through an indeterminate number of rules depicted by rule-n 440. A number of rules 422 are associated with each of the representative modes 402B, 404B, 406B. For the normal mode 402B, a number of rules 422 have been associated therewith, including rule-1 424, rule-3 428, rule-4 430, and rule-7 436. The smart mode 404B is associated with rule-1 424, rule-2 426, rule-3 428, rule-5 432, rule-6 434, and rule-8 438. The user-1 mode 406B is associated with rule-2 426, rule-3 428, rule-4 430, and rule-8 438.

When the user selects one of the modes 402A, 404A, 406A via the user interface 400, the rules that have been associated with the selected mode are activated, and thereby used in rendering content for use on the device. As a more particular example, a mobile terminal user may select the smart mode 404A via a menu 400, which activates 30 rule-1 424, rule-2 426, rule-3 428, rule-5 432, rule-6 434, and rule-8 438 as shown in the table 420. These rules could, for example, determine the manner in which images, graphics, text, etc. is presented via the mobile terminal. In other words, the browser will render the Internet content according to the rules associated with the smart mode 404A, 404B. This is all performed without requiring the content provider to provide specially-adapted content to suit the particular class of mobile terminal that is accessing the content.

The exemplary modes shown in FIG. 4 are described as representative modes, and additional, fewer, and/or different modes may alternatively be used. The modes shown in FIG. 4 include the normal mode, smart mode, and user mode (i.e., user-1 mode). In one embodiment of the invention, the “normal” browsing mode is used, where the browser renders Internet (or other) content as closely as possible to how it was originally intended. This may include maintaining, to the extent possible, the page structure and aspect ratios of page components. From a user perspective, this provides the ability to view Internet content in its originally intended format, bringing with it all of the potential difficulties resulting from the mobile terminal's smaller display screen. For example, the text may be relatively small and difficult to read, there may be a need to scroll horizontally and/or vertically to view a page, etc. The rules associated with a normal browsing mode may be factory preset and optimized for browsing Internet content as the author originally intended.

In one embodiment, the smart browsing mode may be activated, where the browser renders Internet (or other) content in the most suitable and intuitive manner for a small display. For example, this mode contemplates the ability to fit the content to the size of the particular terminal display while avoiding, for example, the need for horizontal scrolling and while maintaining maximum legibility of the actual content. In practice, page elements such as frames, tables, pictures, text, etc. are dealt with in an “intelligent” manner and remain clearly visible to the user.

One or more user modes may also be used in connection with the browser of the present invention. With a user mode activated, the browser renders Internet (or other) content according to the rules set by the user (or another such as a content provider). The user has the ability to activate and configure rules, thereby customizing the manner in which the browser will render the actual content. The user may save these settings, for example, under a personal name or other designator. The user may create as many personalized user modes as desired, and as allowed by the particular implementation. A user mode can also be locked to prevent a user from being able to change its settings. This may be useful where, for example, another party such as an operator or content provider wishes to preload a pre-configured “user” mode onto the browser for use with their service.

Further, in some embodiments, certain rules can be masked from the user and only made available through a configuration file for certain users, in order to make for a more simple user interface for the typical user by limiting the number of choices available to the user. Also, certain rules can be entirely locked out from user access so that the user is unable to change the setting of a certain rule.

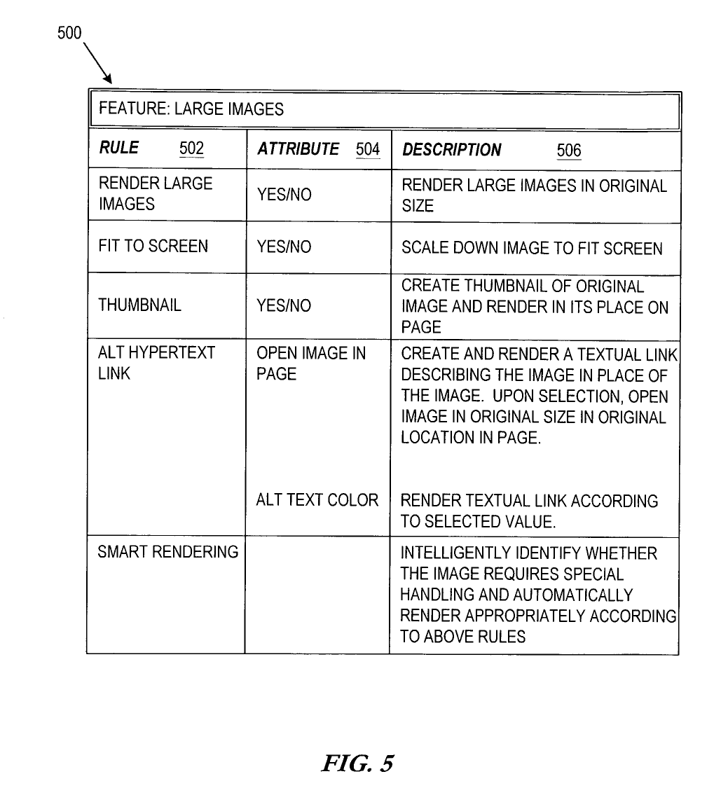

FIG. 5 illustrates an exemplary feature in accordance with one embodiment of the present invention. As previously indicated, a “feature” is a collection of rules that are related to a particular rendering task. In the example of FIG. 5, the feature 500 includes rules 502 that are related to the rendering of large images from Internet content. A first rule 502 is to render the images as large images. The associated attribute 504 is a yes/no designation as to whether the images will be rendered as large images on the local display, as set forth in the description 506. If the user decides to activate this rule in accordance with the yes/no attribute 504, the image will be rendered on the mobile terminal, for example, in its original size thereby potentially requiring scrolling to view the image in its entirety. If the user chooses not to activate this rule which relates to the “no” attribute 504, the images will not be rendered in its original size.

Another rule 502 is to fit the image to the local display screen. The associated attribute 504 is again a yes/no attribute designating whether the image will be scaled down to fit the screen, as set forth in the description 506. If the user decides to activate this rule in accordance with the yes/no attribute 504, the image will be rendered on the mobile terminal as an image sufficiently scaled down to fit on the mobile terminal display screen. Similarly, another rule 502 is a thumbnail rule, having a yes/no attribute 504. If the thumbnail rule is activated, a thumbnail image of the original image is created and rendered in its place on the page, as set forth in the description 506. It should be noted that some of the rules associated with a feature 500 may be mutually exclusive. For example, if the user designates that the large image will be rendered in its original size, other rules 502 such as the “fit to screen” and “thumbnail” rules may be disabled.

Another rule 502 associated with the exemplary large images feature 500 is an alternative hypertext link rule. One attribute 504 associated with such a rule is to open the image in the page. With this rule, a textual link is created and rendered that describes the image in place of the image. Upon selection of the textual link, the image is opened, for example, in its original size in its original location in the page. Thus, when the alternative hypertext link rule is activated, the textual link will be presented, and the user has the option of opening the image in the page. Another attribute 504 associated with this rule is to provide an alternative text color, where the textual link will be rendered according to the selected value.

Another rule associated with the feature 500 is a smart rendering rule. Activation of this rule intelligently identifies whether the image requires special handling, and automatically renders the content appropriately according to the other rules of this feature.

FIG. 5 provides an example of a representative feature used to manage the rendering of large images in accordance with the principles of the present invention. In a similar manner, rules can be used to control all aspects of Internet content, such as images, text, tables, frames, banners, audio, video, windowing, etc.

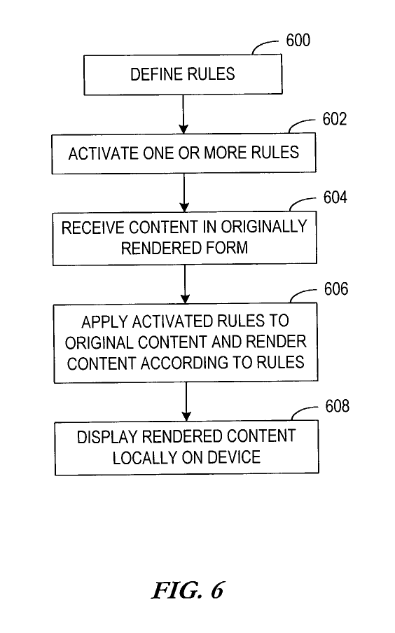

FIG. 6 is a flow diagram of an exemplary manner of locally rendering content for presentation on a local device in accordance with one embodiment of the present invention. One or more rules are defined 600, which may include individual rules, as well as features or other groups of rules. These rules may be defined by the user, or may be defined by other entities such as the device manufacturer, network operator, service provider, content provider, etc. Definition 600 of the rules includes original definition of rules, the creation of new rules, as well as the ability to redefine existing rules that allow for such redefinition.

Any number of rules may be provided. Of the existing rules, one or more of these rules are activated 602. For example, depending on various parameters including the device and content characteristics, some rules may be activated 602 while others are left inactivated. Content is received 604 at the device in its originally rendered form. For example, Internet content may be received as the content author originally intended such content to be viewed. This original form may include content characteristics such as image size, text size and color, graphics and/or video presentations, tables, banners, frames, audio, and the like. When the device (e.g., mobile terminal) receives this original content, a browser module employing the principles of the present invention applies 606 the activated rules to the original content, and renders the content according to these activated rules. The content, rendered according to the activated rules, is locally displayed 608 on the device.

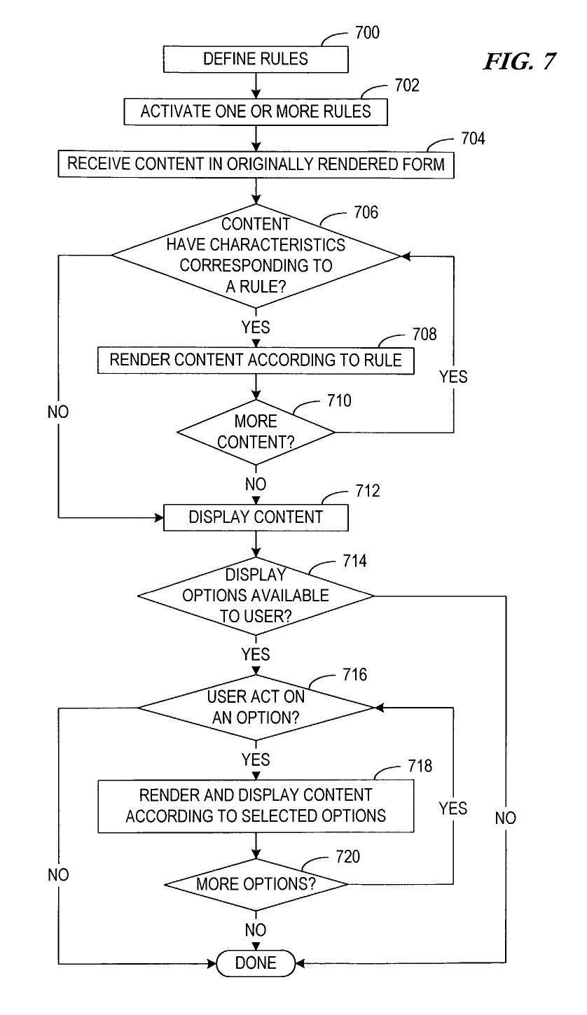

FIG. 7 is a flow diagram of another exemplary embodiment for locally rendering content for presentation on a local device in accordance with the present invention. One or more rules are defined 700, which may include individual rules, as well as features or other groups of rules. As described above, these rules may be defined by the user, or may be defined by other entities such as the device manufacturer, network operator, service provider, content provider, etc. One or more of these rules are activated 702 to cause the content to be subjected to these activated rules. Content, such as Internet content, is received 704 at the device in its originally rendered form. If the content does not have characteristics corresponding to an activated rule, the content is simply displayed 712. If, on the other hand, the content has characteristics corresponding to a rule as determined at decision block 706, the content will be rendered 708 according to that rule. For example, a rule(s) may be activated to render images in a manner more suitable for a smaller display on a mobile terminal. In such a case, if the received content includes images, then the content has characteristics corresponding to one or more activated rules, the content will be rendered 708 according to that rule(s). If there is more content for consideration as determined at decision block 710, it is again determined 706 whether that portion of the content exhibits characteristics subject to an activated rule. On the other hand, if the activated rule(s) relates to rendering images, but the content includes only text, then that particular content does not exhibit characteristics subject to an activated rule, and the content can simply be displayed 712.

In one embodiment of the invention, there may be display options available to the user after the content has been locally presented on the user device. For example, an activated rule that has been applied may present a thumbnail image in place of the actual image, or may present a link, blank placeholder, or other visual cue corresponding to the actual image. Some rules provide the user with the option of selecting the thumbnail, link, blank placeholder, etc., which upon selection presents the actual image. A wide variety of other options may be presented to the user for any type of content locally presented on the device. Where no such display options are available to the user as determined at decision block 714, the rendering and display process for that particular content is complete. Where such display options are available to the user as determined at decision block 714, the user may opt to act on one or more of these options as determined at decision block 716. If the user decides not to act on any available options, the rendering and display process for that particular content is complete. Otherwise, if the user acts on an option as determined at decision block 716, the content is rendered and displayed 718 according to the selected option corresponding to another rule(s). If there are more options available to the user as determined at decision block 720, the user is again presented with the opportunity 716 to act on such an option.

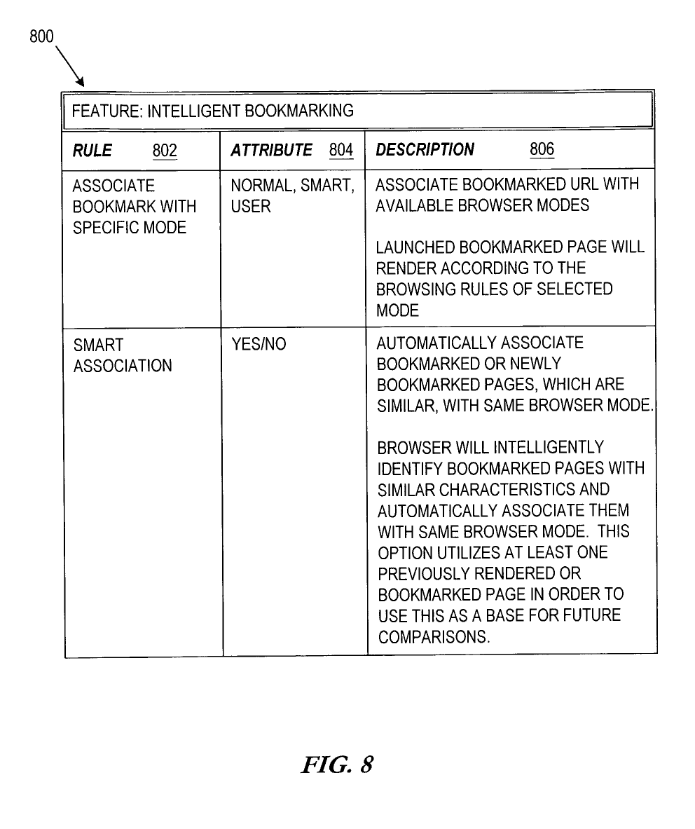

As previously described, the local rendering rules associated with the present invention may be grouped into features. One exemplary feature was described in connection with FIG. 5. FIG. 8 illustrates another exemplary feature in accordance with the present invention. In the example of FIG. 8, the feature 800 includes rules 802 that are related to intelligent bookmarking in accordance with the present invention. The various “modes” may be associated with bookmarked pages in the smart browser, as described below.

A first rule 802 relates to associating a bookmark with a specific mode. The attributes 804 associated with this rule include the various modes, such as “normal,” “smart,” and “user” using the example modes described above. As set forth in the illustrated description 806, this rule will associate a bookmarked Uniform Resource Locator (URL) or other network address with the available browser modes. In this case, when the particular bookmarked page(s) is launched, the page will be rendered according to the browsing rules of the selected mode. Alternatively, the bookmarked page(s) may be associated with particular rules, without specifically being associated with a mode.

Another rule is the smart association rule, having an associated yes/no attribute 804 designating whether the smart association rule is activated. If the user decides to activate this rule, currently bookmarked pages and/or newly bookmarked pages that are similar to other bookmarks already associated with a particular mode will automatically be associated with that mode. More particularly, the browser will intelligently identify bookmarked pages having similar characteristics, and automatically associate them with the same browser mode. In one embodiment, this option makes use of at least one previously rendered or bookmarked page in order to provide a basis for future comparisons. For example, a particular rendered and/or bookmarked page may be associated with a user mode which includes rules specifying that images are to be displayed as thumbnail images. A new bookmark created for another page, having similar image characteristics, can be automatically associated with that user mode when the smart association rule has been activated. In this manner, when the new bookmark is launched, it will be rendered according to the rules associated with the automatically selected mode.

As previously described, “user” modes may be created by the user of the mobile terminal, or may be created by Internet content providers. User modes provided by such content providers may be referred to herein as profiles customized for specific devices and their Internet content. These modes may be downloaded by the user from the content provider's network site onto the smart browser on the user's device, directly via the Internet, over-the-air (OTA), etc., depending on the type of device and how it is connected to the Internet. The profile can then be saved as another “user mode,” which can be identified, for example, by using the content provider's name or other designation. Such a pre-configured user mode can optionally be locked to prevent the user from changing the settings and/or mode name.

In this manner, it is not necessary for a content provider to change the look of their site to suit a specific user agent and/or device's characteristics and capabilities. The content provider need only test their content with the target device that will run the smart browser in accordance with the present invention, and to continue to “tune” the browser, where necessary, by configuring and re-configuring the user mode until their content appears optimal on the target device and smart browser. A service provider, such as a mobile network operator, may also be able to preload their own pre-configured (and optionally locked) user modes onto the smart browser in a mobile terminal, in order to be used with their own content. These and other characteristics make the smart browser of the present invention a modular platform that can be best configured to suit any class of device, and any kind of network/Internet content, thereby allowing any network/Internet content to be optimally presented on any type of device.

Another feature in accordance with the present invention is a smart hotspot feature. Since some devices, such a mobile terminals, have displays that are smaller and have lower resolution than their desktop counterparts, Internet content may be scaled down when rendered onto the smaller screen. However, when scaled down in this fashion, a complex page with many components may prove to be difficult and frustrating for the user to manipulate and view on a small device display. Some content may not even be legible when scaled down in this fashion, due to the small size of the display when reformatted. The problem is particularly prevalent in connection with large and complex bitmaps, which are generally designed for a high-resolution display. When such large and complex bitmaps are rendered onto small displays, the content may simply be too small or the mobile terminal display may not have sufficiently high resolution to adequately view the content. A smart hotspot feature in accordance with the present invention solves potential problems of dealing with such clickable bitmaps, by providing the user with an option to use a smart hotspot feature in accordance with the present invention.

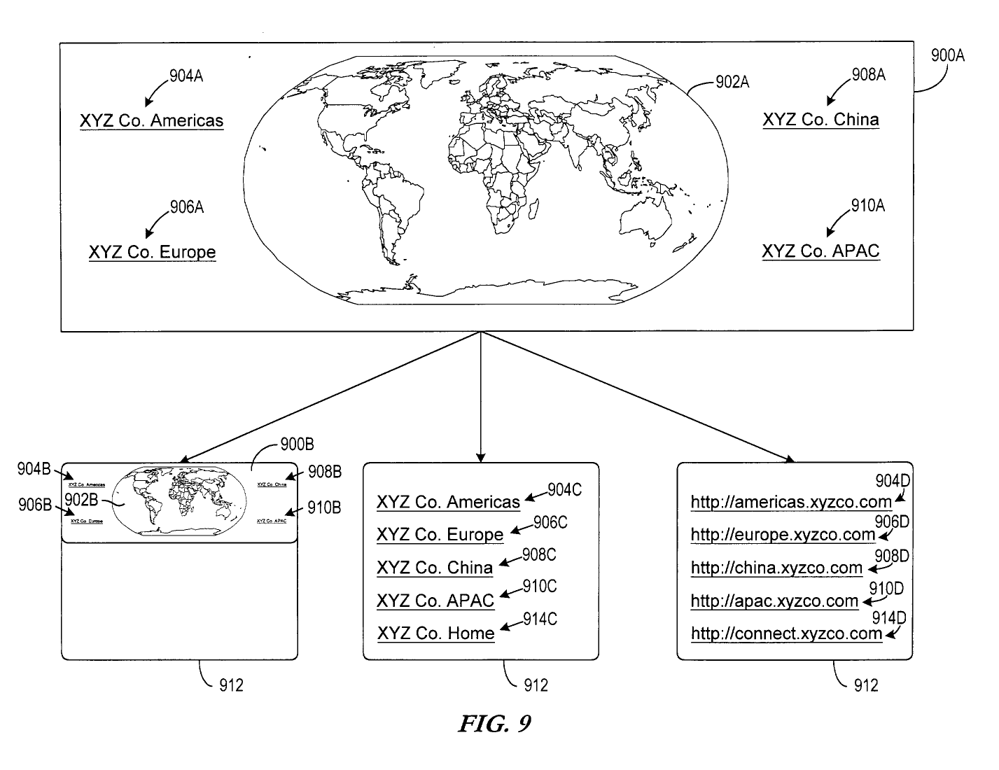

More particularly, scaling down clickable bitmaps can cause problems, particularly where the bitmap includes a significant amount of details and HTML links. The details of a scaled down bitmap can become unintelligible to the user. This can be seen in FIG. 9, which illustrates originally-rendered content 900A that is to be scaled down for display on a smaller screen, such as a mobile terminal display screen. In FIG. 9, the content 900A represents a banner or other Internet content. The representative banner 900A includes an image 902A, as well as a number of embedded hyperlinks 904A, 906A, 908A, and 910A, i.e., “hotspots” at certain coordinates.

In the illustrated example, the banner 900A is scaled down to fit to the size of a small display 912. When the banner 900A is scaled down to banner 900B, the banner's textual components, which include embedded hyperlinks 904B, 906B, 908B, and 910B, become unreadable. The banner 900B, which is a “clickable bitmap” in the illustrated embodiment, is thus very difficult for the user to properly utilize, as it can be difficult to ascertain where the hotspots actually are and to distinguish between the hotspots.

One embodiment of the present invention employs a smart hotspots feature. When activated, this feature, comprising one or more rules, displays the hotspots of the bitmap as textual hyperlinks, textual labels, etc. in place of the actual bitmap on the page. For example, a number of labels may be presented on the display 912, such as the labels 904C, 906C, 908C, and 910C. These labels correspond to the otherwise unintelligible embedded hyperlinks 904B, 906B, 908B, 910B. Similarly, the links 904D, 906D, 908D, and 910D may alternatively be presented. Additional labels and links may also be presented such as 914C and 914D, which are labels/links directing the user to the home page (or other predetermined page) of the particular site. Thus, in the illustrated embodiment, the image 902B is not displayed, and the remaining links 904B, 906B, 908B, 910B are presented in a more intelligible manner to the user, by increasing the size of the link/label. Increasing the size of the label/link may utilize a larger portion of the display 912, as shown in FIG. 9.

While the illustrated embodiment is described in terms of textual links/labels, other indicia may be used, such as a newly rendered image. For example, rather than using the “XYZ Co. China” label/link 908C, 908D, an image such as a larger map image of China may be alternatively presented. Other identifying indicia may also be used. For example a company trademark or service mark associated with each of the selections, or other indicia distinguishing between each choice such as a monetary symbol for that region or other distinguishing icon.

In one embodiment, the user is provided with a choice as to whether or not to render clickable bitmaps or other images in this fashion. For example, the user may be presented with a pop-up screen asking whether the user would like to activate the smart hotspots feature, from which the user may make the appropriate selection. Alternatively, a designated user interface mechanism may be provided, such as a button, menu item, audio command interface, etc. from which the user may initiate such a feature.

To implement such a feature, the URLs/hotspots embedded in the clickable bitmap are identified. Rendering of textual labels or other indicia describing the URLs involves, for example, including an alternative text description or indicia of the hyperlink in the code (e.g., HTML code). Other methodologies may also be used whereby the browser can identify the link labels from the actual clickable bitmap.

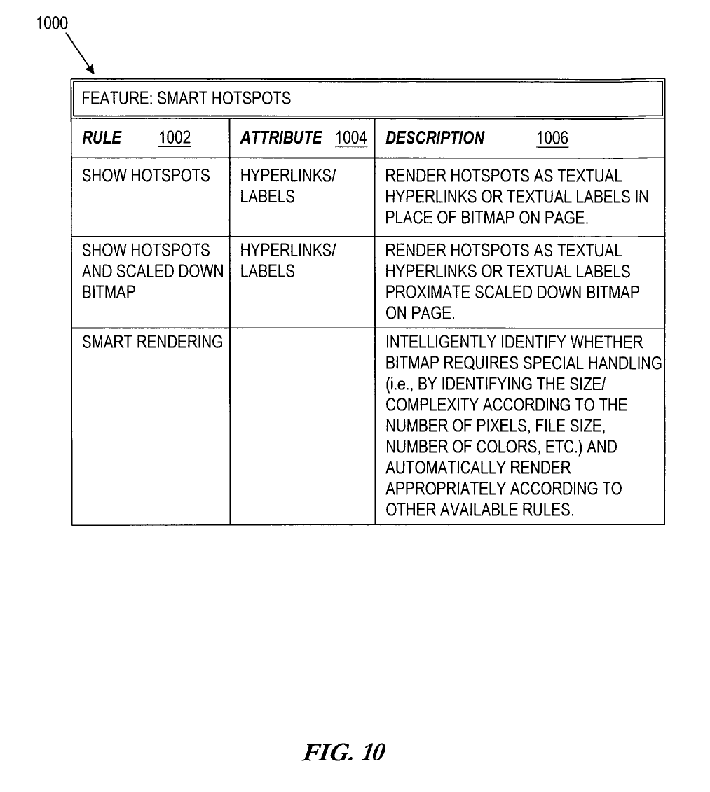

FIG. 10 illustrates an exemplary smart hotspots feature in accordance with the principles of the present invention. In the example of FIG. 10, the feature 1000 includes rules 1002 that are related to a smart hotspots operation in accordance with the present invention. A first rule 1002 is to “show hotspots.” The associated attribute 1004 is a hyperlinks/labels selection to designate whether the hotspots will be rendered as hyperlinks or labels. As previously described, other selection choices may also be provided as attributes, such as distinguishing images (e.g., country/region map symbols, monetary symbols, etc.) If the user decides to activate this rule in accordance with one of the attributes, the hotspots will be displayed on the mobile terminal in accordance with the selected attribute, in place of the bitmap on the page as set forth in the description 1006. For example, if the user activates the “show hotspots” rule, and identifies that labels are the desired attribute, then the hotspots will be rendered such as shown in FIG. 9 as labels 904C, 906C, 908C, 910C. If the user activates the “show hotspots” rule, and identifies that hyperlinks are the desired attribute, then the hotspots will be rendered such as shown in FIG. 9 as labels 904D, 906D, 908D, 910D.

Another rule 1002 is to show the hotspots as well as a scaled down bitmap. The associated attribute 1004 is a hyperlinks/labels selection to designate whether the hotspots will be rendered as hyperlinks or labels. If the user decides to activate this rule in accordance with one of the attributes, the hotspots will be displayed on the mobile terminal in accordance with the selected attribute, in addition to a scaled down bitmap on the page as set forth in the description 1006. This may result in a smaller area in which the labels/hyperlinks may be displayed, but this area may be adequate depending on the quantity and size of the required labels/hyperlinks.

Another rule 1002 is to utilize smart rendering. If the user decides to activate this rule, it will be intelligently determined whether the bitmap requires special handling, and rendering will automatically be performed based on one or more other hotspot rules such as the “show hotspots” or “show hotspots and scaled down bitmap” rules. This intelligent determination may be based on any one or more predetermined characteristics of the original bitmap, such as the size and/or complexity of the bitmap which may be based on, for example, the number of pixels, the file size, the number of colors utilized, etc.

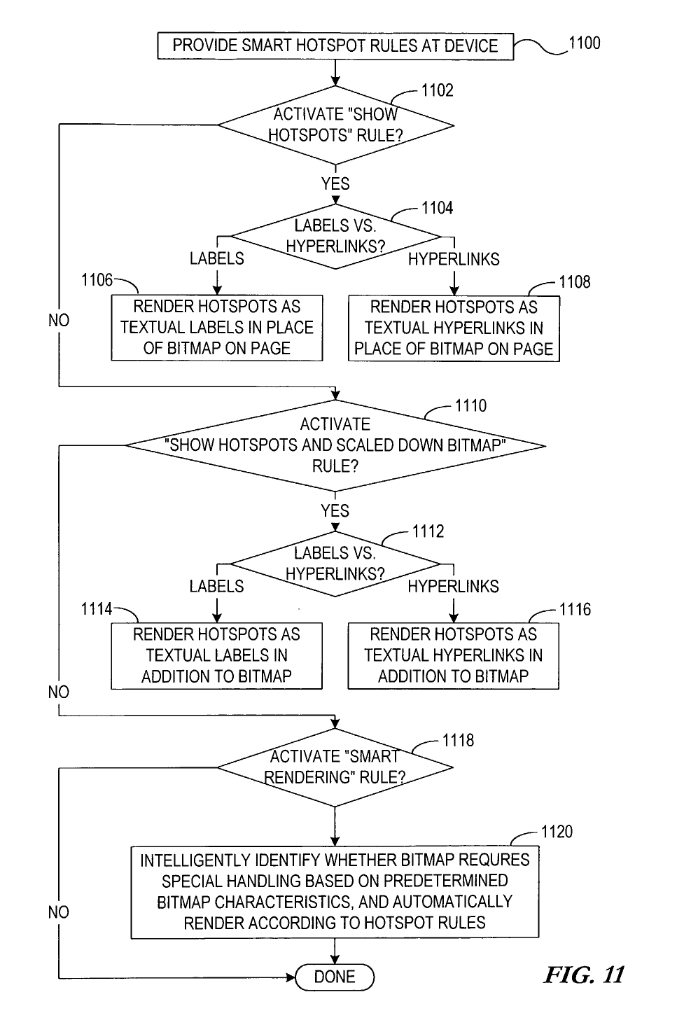

FIG. 11 is a flow diagram illustrating an exemplary method for employing a hotspots feature in accordance with the present invention. Smart hotspot rules are provided 1100 at the device. These rules may be created by the user, or may be provided by a network operator, service provider, content provider, etc. If a show hotspots rule is activated as determined at decision block 1102, it is determined 1104 whether hyperlinks or labels will be presented. Other attributes could also be provided to the user, but for purposes of this description, labels and hyperlinks are the attribute options provided to the user. If the user chooses labels, then the hotspots are rendered 1106 as textual labels in place of the bitmap on the page. If the user chooses hyperlinks, then the hotspots are rendered 1108 as textual hyperlinks in place of the bitmap on the page.

If a different rule directed to showing the hotspots as well as a scaled down bitmap is selected as determined at decision block 1110, it is determined 1112 whether hyperlinks or labels will be presented. If the user chooses labels, then the hotspots are rendered 1114 as textual labels in addition to a scaled down bitmap on the page. If the user chooses hyperlinks, then the hotspots are rendered 1116 as textual hyperlinks in addition to a scaled down bitmap on the page.

A smart rendering rule may also be selected. If the smart rendering rule is chosen as determined at decision block 1118, the local browser will intelligently determine whether a bitmap requires special handling based on predetermined bitmap characteristics. Such characteristics may include, for example, the size and/or complexity of the bitmap which may be gauged by the number of pixels, file size, number of colors, etc. If it is determined that special handling is required, rendering will be automatically performed according to one or more particular hotspot rules, such as those previously described in connection with blocks 1106, 1108, 1114, 1116. It should be recognized that while FIG. 11 is described in terms of three available rules associated with the smart hotspots feature, more, fewer, and/or different rules may analogously be employed.

Another feature in accordance with the present invention is a smart element control feature. Because some displays such as mobile terminal displays have smaller display screens and/or lower resolutions than that of larger computer displays generally targeted for certain content such as Internet content, such Internet (or other) content will be scaled down when rendered onto the smaller screen. This makes complex content containing elements such as frames, banners, large detailed pictures, etc. difficult for the user to manipulate and discern. A browser employing a smart element control feature in accordance with the present invention provides a solution to this problem by assisting users with navigation and manipulation of such content. The smart element control feature is used in order to highlight and/or select various page elements, such as frames, banners, tables, pictures, etc., to which certain rules can be applied thereto to facilitate rendering of such elements for viewing on a display.

More particularly, the user can specify, through attributes for example, the desired elements or combination of elements that the browser should identify. For example, these selectable attributes may include all page frames, all page frames and pictures, etc. The user can also specify whether the browser should automatically identify and highlight all page elements during or after loading, or alternatively whether such elements should be identified and highlighted by the user when selected by the user. Highlight colors or other characteristics may also be specified, or highlighting of the elements may be turned off completely.

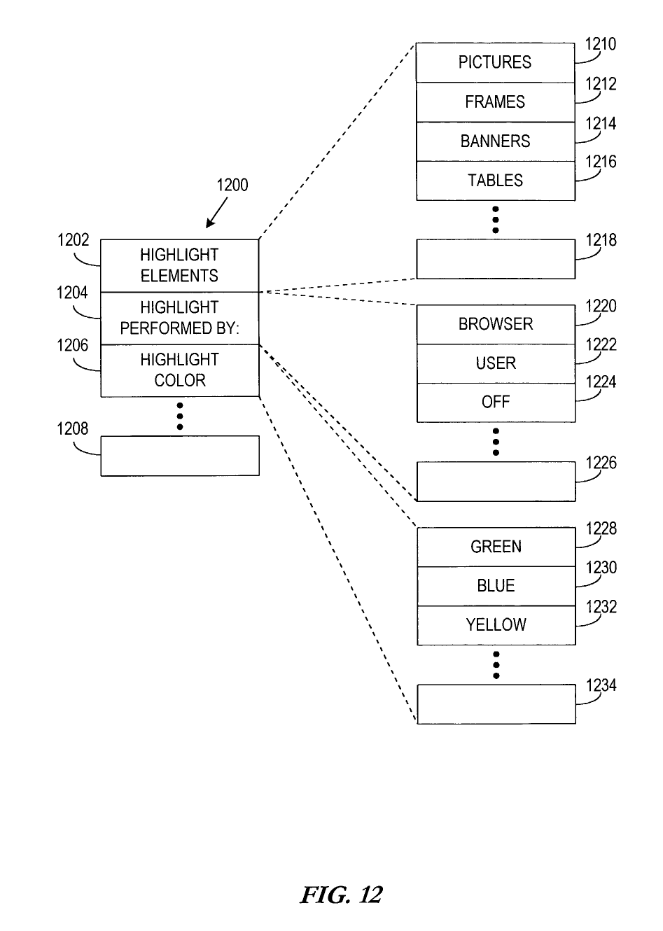

FIG. 12 illustrates an exemplary user interface in which smart element control may be configured in accordance with one embodiment of the invention. The user interface in the illustrated embodiment is a menu 1200, including various configuration options in which the user can make a selection. A first menu item 1202 provides a highlight choice option. Selection of this item 1202 may present a sub-menu, including one or more element types from which the user may designate such elements to be highlighted. Highlighting in accordance with this embodiment of the invention refers to any manner of emphasizing or otherwise distinguishing the element as one that may be subject to the element control functions. For example, highlighting may include highlighting using colors, distinguishing borders, flashing borders and/or elements, associated icons (e.g., arrow), and the like. When the user selects the highlight elements menu item 1202, a selectable sub-menu may be provided that includes, for example, various elements types such as pictures 1210, frames 1212, banners 1214, tables 1216, or other 1218 element types. The user can select one or more of the element types 1210-1218 to designate which elements can or will be highlighted.

Another menu item 1204 allows designation of who or what will perform the highlighting. This menu item 1204 may be associated with one or more sub-menu items, including the browser sub-menu item 1220, user sub-menu item 1222, an off submenu item 1224, or other sub-menu items 1226. If the user selects the browser sub-menu item 1220, the browser will automatically highlight those elements designated in connection with the “highlight elements” menu item 1202. If the user selects the user sub-menu item 1222, the user will manually highlight those elements available for highlighting through designation in connection with the “highlight elements” menu item 1202. If the user selects the off sub-menu item 1224, element highlighting is turned off completely.

Another menu item 1206 allows designation of a highlight color. As previously described, highlighting may be made using colors, borders, or any other distinguishing characteristic. In the illustrated embodiment, highlighting colors are used as the distinguishing characteristic. When menu item 1206 is selected, a sub-menu may be presented to the user, including sub-menu items green 1228, blue 1230, yellow 1232, etc. The particular one or more elements designated via menu item 1202 will then be highlighted according to the color designated via menu item 1206, and will be performed by the performer designated in connection with menu item 1204. It should be recognized that any user interface mechanism or methodology may be used in connection with, or in lieu of, the menu-driven user interface depicted in FIG. 12, such as buttons, switches, touch screen selection, text entry, audio command interface, etc.

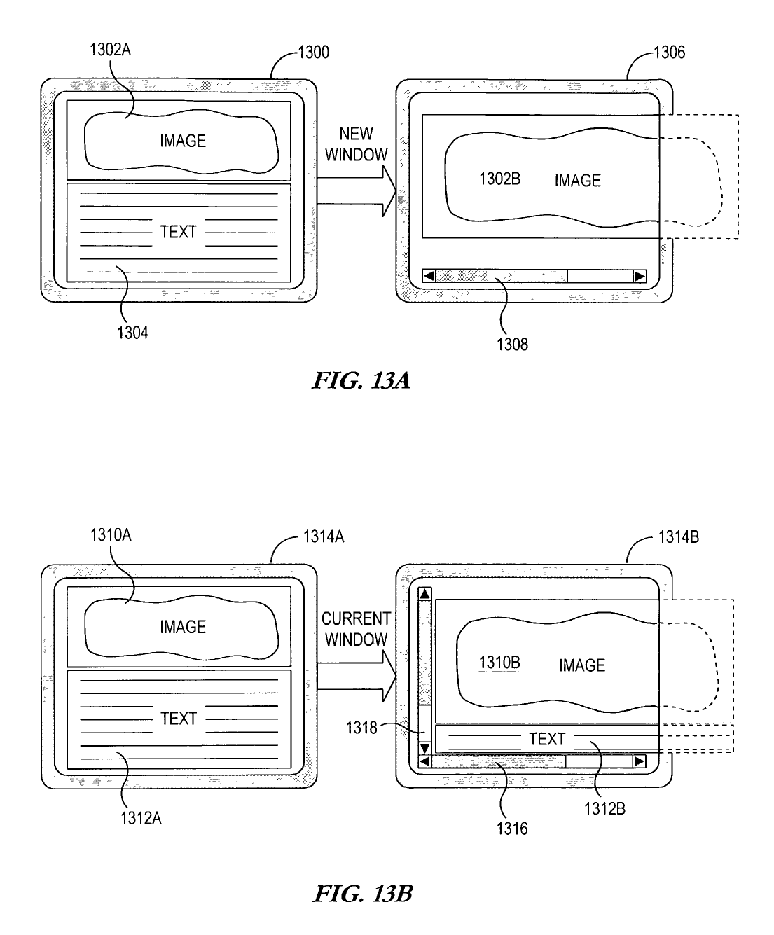

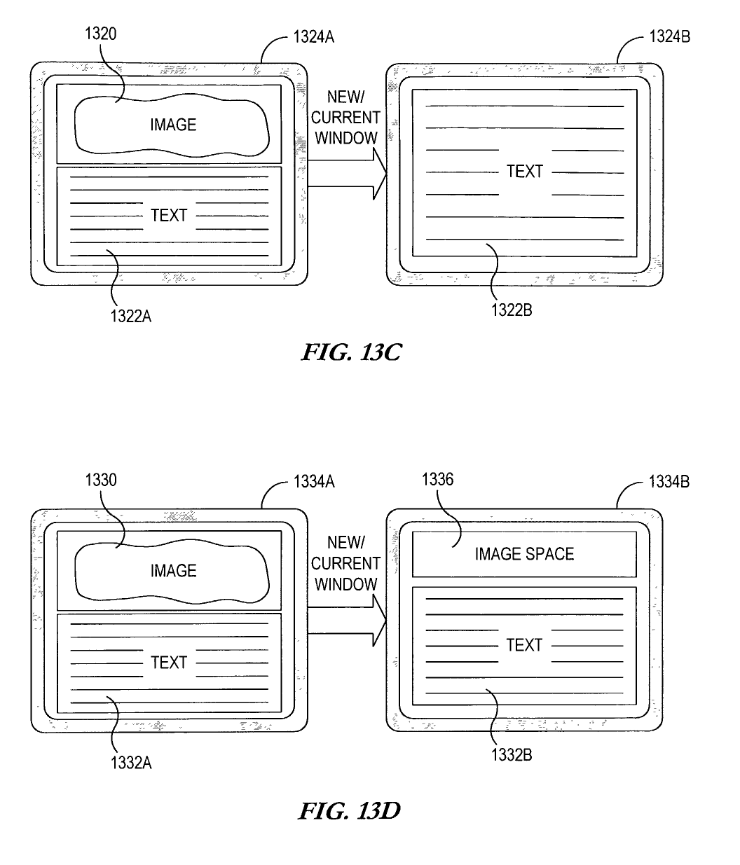

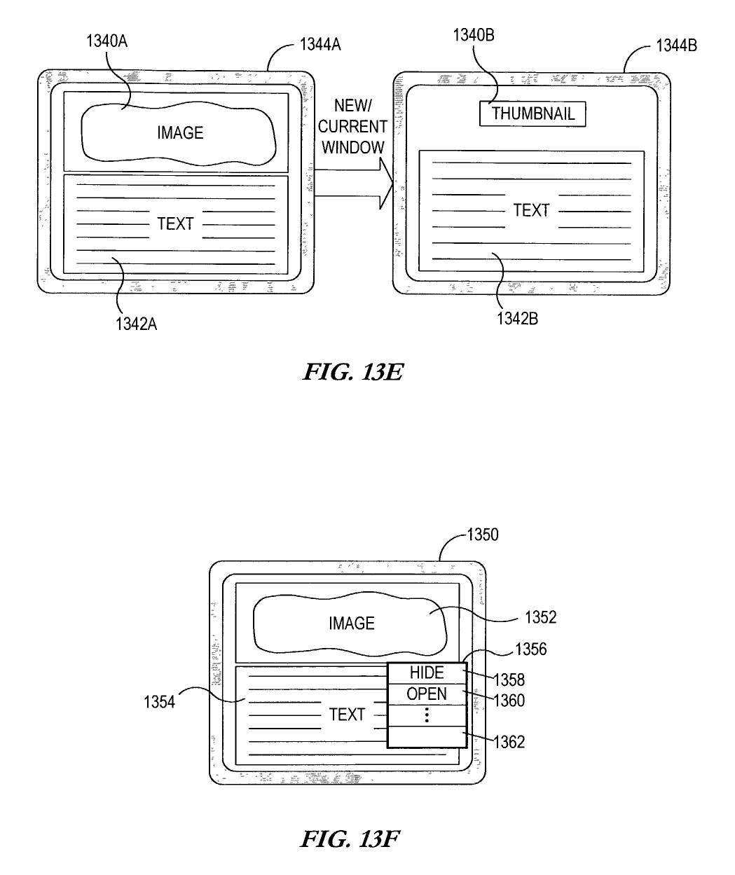

In order to illustrate the smart element control operation in accordance with the present invention, FIGS. 13A-13F are provided. These figures provide representative examples of how an action is applied to an element(s). It should be recognized that the illustrated embodiments of FIGS. 13A-13F are provided for purposes of illustration only, and the smart element control in connection with the present invention is clearly not limited to the illustrated examples.

Once at least one element has been highlighted and the highlighted item has been selected (e.g., through a mouse click selection or other graphical selection), any number of actions can be performed. As a first example, FIG. 13A illustrates that a highlighted element may be opened in its original size in a new window. The image 1302A and/or text portion 1304 of the original content is generally scaled down to fit on a smaller display window 1300. In the example of FIG. 13A, the scaled down image 1302A is presented in a new display window 1306 as image 1302B in its originally intended size. This may require, however, that the user scroll the image 1302B to be seen in its entirety. This potential scrolling operation is depicted by the horizontal scroll bar 1308, although it should be recognized that such a scroll bar 1308 need not be displayed. In this particular embodiment, the text 1304 is not presented in the new display window 1306. An alternative method is to scale the element back down upon selecting the image 1302B. In such an embodiment, one manner of allowing this is to provide a menu option in the browser that provides the option to scale down original size elements, or even an option relating to particular elements such as an option to scale down all original size frames.

FIG. 13B illustrates another example where the element, when selected, is opened in its original size in its original location in the current window. More particularly, the image 1310A and the text portion 1312A is rendered onto display window 1314A. When the appropriate rule(s) has been activated, and when the highlighted image 1310A is selected, the image 1310B is displayed in its original size and original location in the current display window 1314B. The text 1312A may or may not be rendered as text 1312B in original size and original location in display window 1314B, depending on the particular implementation. By rendering the image 1310B and possibly the text 1312B in original size and location in display window 1314B, the user may need to scroll in order to view the image 1310B and/or text 1312B in its entirety. This potential scrolling operation is depicted by the horizontal scroll bar 1316 and vertical scroll bar 1318, although it should be recognized that actual horizontal/vertical scroll bars need not be presented to the user.

FIG. 13C illustrates another embodiment, where the element is hidden in the page when selected, and the page is filled with remaining content. More particularly, the image 1320 and text 1322A may be presented in display window 1324A. Upon selection of the image 1320 element, the image 1320 is hidden in the current or new display window 1324B, thereby filling the window 1324B with remaining content which in the illustrated example is the text 1322B. The text 1322B is therefore provided maximum display area by hiding the image 1320, and the text may optionally be presented in a more readable format (e.g., larger, different font, etc.).

FIG. 13D illustrates a similar example, where the element is hidden in the page when selected, but a visual placeholder is displayed to indicate where the image once was. More particularly, the image 1330 and text 1332A may be presented in display window 1334A. Upon selection of the image 1330 element, the image 1330 is hidden in the current or new display window 1334B, but a visual space 1336 is displayed to identify where the image 1330 once was. The visual space 1336 may be designated in any desired manner, such as a colored or otherwise highlighted area, an icon representing the type of element, etc. The remaining portion of the display window 1334B may be filled with remaining content which in the illustrated example is the text 1332B. Another embodiment involves reversing that of FIG. 13D, where a hidden element is shown when a corresponding visual space 1336 is selected. An alternative method is a menu option in the browser that provides an option to show all hidden elements, or even relating to particular elements such as an option to show all hidden frames.

FIG. 13E illustrates another embodiment, where a thumbnail of the element is rendered in place of the original element. More particularly, the image 1340A in display window 1344A can be rendered as a thumbnail 1340B in the current or new display window 1344B. Other content, such as the text 1342A, can then be rendered as text 1342B in the current/new window 1344B. Alternative embodiments include reverting the thumbnail 1340B back to its previous size upon selection of the thumbnail 1340B, or opening the thumbnail 1340B in its original size in a new window similar to that described in connection with FIG. 13A. Another embodiment involves creating a textual link describing the element 1340A, where the textual link is provided instead of the thumbnail 1340B in current/new display window 1344B. Yet another embodiment involves stopping loading of the individual element upon its selection, while the element is still loading. This is helpful in progressive loading situations or loading of large elements where there is minimal bandwidth available.

Actions may be applied at once to all elements in the same category, to individual elements, to all elements identified in all categories, or any combination thereof. The action to be applied to the element(s) upon selection can be preset through a browser configuration menu and then applied, or may be selected through, for example, a pop-up menu that appears close to the element when the cursor or other selection indicia is associated with that element. FIG. 13F illustrates such an example. Within the display window 1350 may be one or more elements, such as an image element 1352 and a text element 1354. In one embodiment, a cursor may be placed over, or in a predetermined proximity of, the image 1352, which automatically presents a menu 1356. The menu may include multiple sub-menu items 1358, 1360, 1362, etc., which allows the user to determine the action to be applied to the particular element(s).

Some elements have characteristics further complicating rendering and viewing on small displays such as mobile terminal displays. Tables are one such element, which have layout characteristics that can cause significant difficulties for mobile terminal users. For example, table layout characteristics often include rows and columns, and the information contained therein can be lengthy. Many Internet web pages utilize tables in their design. Rendering such tables on small displays can cause a number of problems. First, if the tables are scaled down such that all of the columns are visible, the associated text and/or images may be too small for proper viewing. Second, if the table information is to be rendered such that it is still adequately viewable, the rows and columns can be extremely difficult to ascertain.

For example, what was intended to be displayed as rows may be wrapped in such a way that the rows and columns are no longer distinguishable, thereby thwarting the purpose of such a structured table. Existing mobile terminal browsers generally render tables row by column sequentially until all of the table cells have been parsed. Since mobile displays are often narrow, the results are compressed in a vertical format, depending on the width of the screen. Tests have found that a rendered page utilizing tables on a small and narrow display can vary depending on how the original web page was designed using tables. In other words, even if the browser was rendering the tables row by column, a web page might appear rendered column by row, due to the manner in which it was implemented. Therefore, the resulting information displayed on smaller display screens may not always be intuitive.

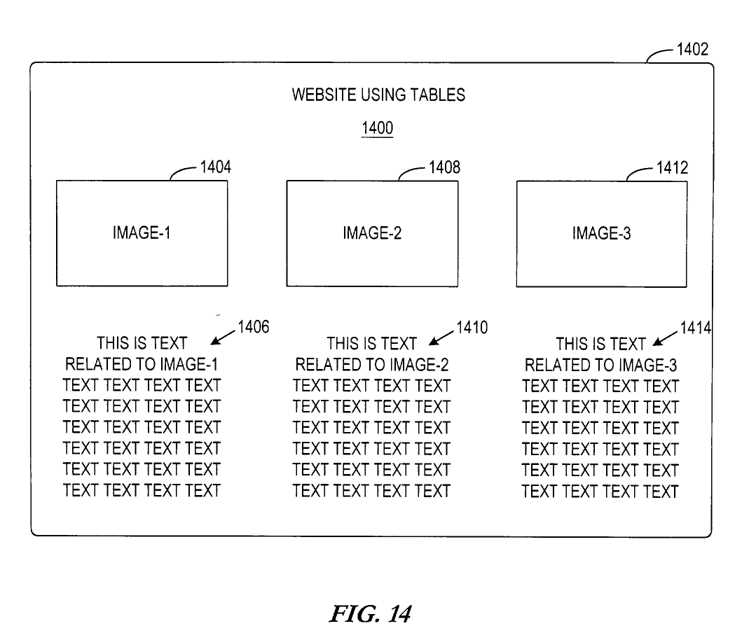

FIG. 14 illustrates a representative Internet web page 1400 that was designed using tables. The web page 1400 may have been designed to fit properly on a display 1402, and each individual element has been placed and positioned on the display 1402 in HTML utilizing row and column elements in a table. More particularly, a first image-1 1404 is displayed in a column with its associated text 1406, image-2 1408 is displayed in a column with its associated text 1410, and image-1 1412 is displayed in a column with its associated text 1414. The three images 1404, 1408, 1412 are arranged in a row, as are each of the text segments 1406, 1410, 1414.

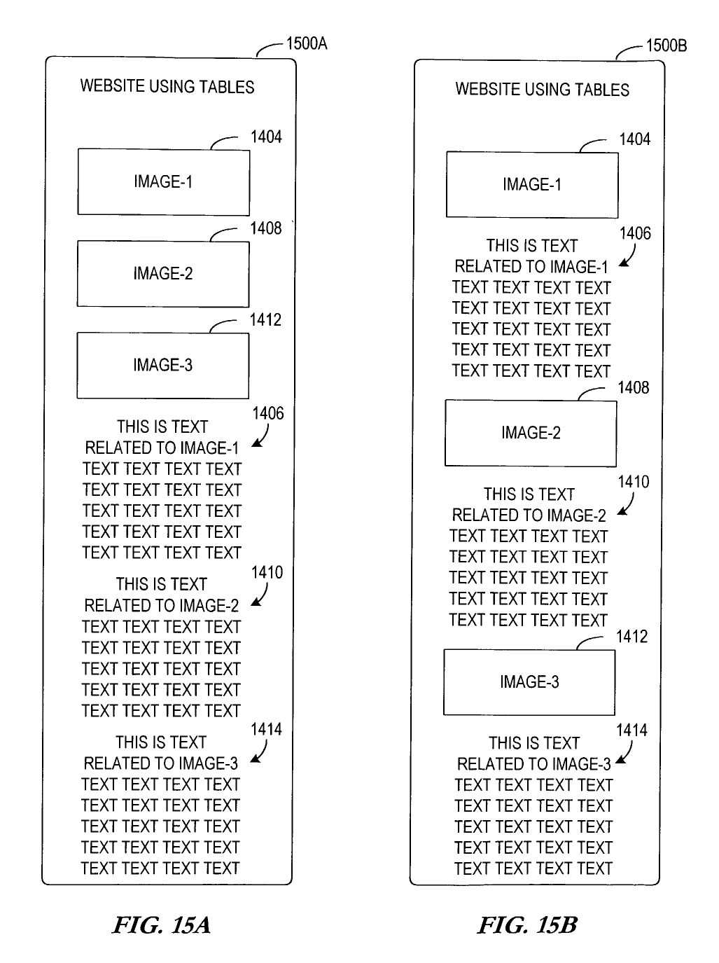

When a web page such as web page 1400 is parsed row by column and rendered on a smaller display, results that are not intuitive can occur. This can be seen in FIG. 15A, which represents the result of parsing the table of FIG. 14 row by column and rendering onto a narrow display 1500A, such as the type of display generally found on a mobile terminal. Using reference numbers corresponding to those in FIG. 14, the row including image-1 1404, image-2 1408, and image-3 1412 have the appearance of being in a column, due to the row by column parsing. Similarly, the row including text segments 1406, 1410, and 1414 also have the appearance of being in a column. Thus, the structure of the table has essentially been lost as a result of rendering the table onto the smaller display 1500A.

The present invention includes a smart table feature that allows the user to choose between the browser rendering the tables row by column or column by row, depending on which is more intuitive to the user. The user may make this selection using a quick menu, shortcut key, or other user interface mechanism. Further, in accordance with the present invention, a rule can be established to parse tables either column by row or row by column. This can be based on the user's general preference, or can be effected automatically by having the browser ascertain the relative web page width, length, number of columns, number of rows, etc., from which a decision can be made as to how to parse the table on the smaller display.

FIG. 15B illustrates how the web page 1400 of FIG. 14 would appear when rendered column by row. As can be seen on the display 1500B, image-1 1404 is positioned proximate its corresponding text segment 1406, image-2 1408 is positioned proximate its corresponding text segment 1410, and image-3 1412 is positioned proximate its corresponding text segment 1414. The result is much more intuitive, as the user views the image first, and then the corresponding text immediately afterwards.

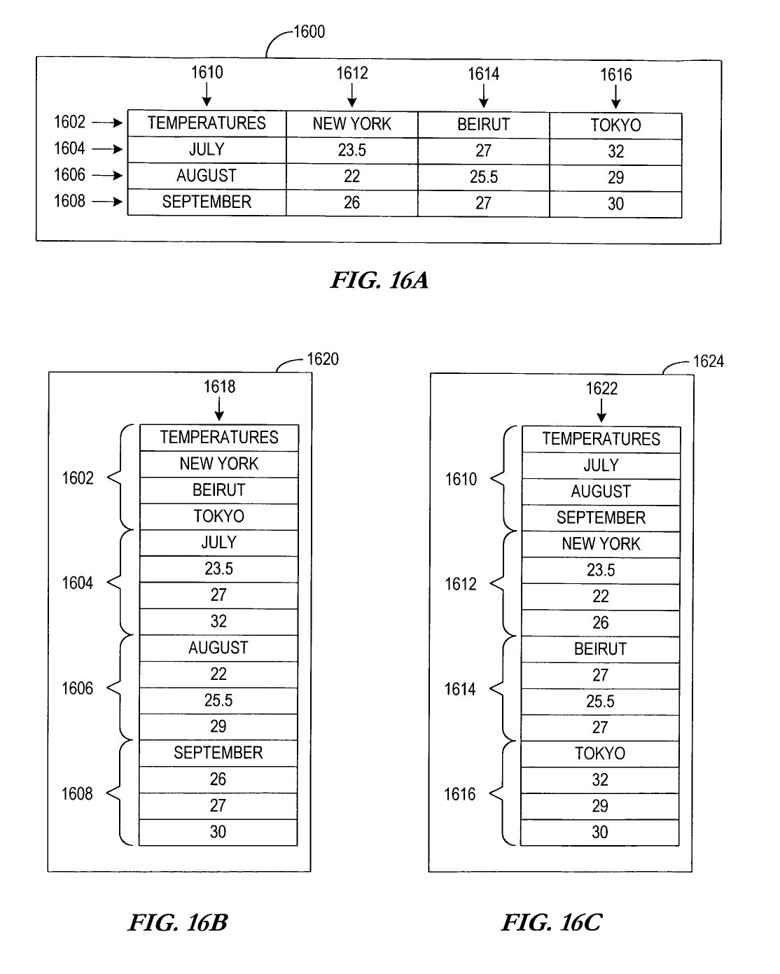

FIGS. 16A, 16B, and 16C further illustrate the manner in which the smart table feature may be used to provide the user with display options. A table associated with a web page is shown on a first display 1600 in its original form. The table includes four rows 1602, 1604, 1606, 1608, and four columns 1610, 1612, 1614, 1616. The user may be presented with an option of parsing the table row by column, or column by row. Alternatively, this decision may be made automatically using rules in accordance with the present invention. FIG. 16B illustrates how the table can be parsed row by column. In this example, a single column 1618 is presented, where each row is presented on the display 1620 as a short column. For example, row 1602 shown in FIG. 16A is presented as a column 1602, as are rows 1604, 1606, and 1608. On the other hand, FIG. 16C illustrates how the table can be parsed column by row. Again a single column 1622 is presented on the display 1624, but in this embodiment each of the columns 1610, 1612, 1614, 1616 are provided stacked on top of one another. Either the user can select the desired format 1618, 1622, or the selection may be made automatically in accordance with the present invention.

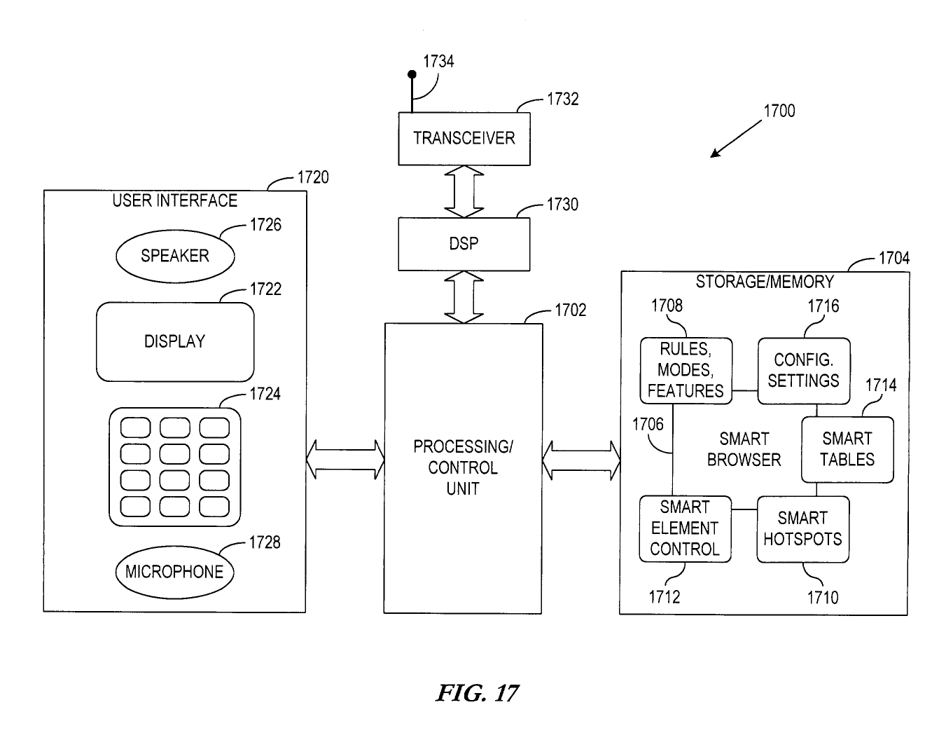

The mobile terminals described in connection with the present invention may be any number of wireless devices incorporating browsers or other applications for viewing web content or other content not specifically designed for smaller devices. These wireless devices include wireless/cellular telephones, personal digital assistants (PDAs), or other wireless handsets, as well as portable computing devices. The mobile terminals utilize computing components to control and manage the conventional device activity as well as the functionality provided by the present invention. Hardware, firmware, software or a combination thereof may be used to perform the various browsing functions and associated features as described herein. Because mobile terminals generally include small displays relative to the systems for which web content is generally designed, an example of a representative mobile terminal computing system capable of carrying out operations in accordance with the invention is illustrated in FIG. 17. It should be recognized, however, that the principles of the present invention are equally applicable to standard computing systems.

The exemplary mobile computing arrangement 1700 suitable for performing the smart browsing functions in accordance with the present invention includes a processing/control unit 1702, such as a microprocessor, reduced instruction set computer (RISC), or other central processing module. The processing unit 1702 need not be a single device, and may include one or more processors. For example, the processing unit 1702 may include a master processor and associated slave processors coupled to communicate with the master processor.

The processing unit 1702 controls the basic functions of the mobile terminal as dictated by programs available in the storage/memory 1704. Thus, the processing unit 1702 executes the functions associated with the smart browsing functions and associated features of the present invention. More particularly, the storage/memory 1704 may include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The smart browser and associated features may also be transmitted to the mobile computing arrangement 1700 via data signals, such as being downloaded electronically via a network, such as the Internet.

One of the programs that may be stored in the storage/memory 1704 is a smart browser program 1706. The smart browser program 1706 facilitates user access to content, such as Internet content and web pages, according to rules, modes, and features 1708 as previously described. Some particular features associated with the smart browser 1706 may be stored in the storage/memory 1704, such as the smart hotspots module 1710, smart element control module 1712, smart table module 1714, etc. The browser 1706 and associated features may be implemented in software and/or firmware operable by way of the processor 1702. Other applications other than browser applications may also be locally stored, where these applications also present links, images, banners, tables, or other selectable items to the user via a display. The present invention is equally applicable to any such application. The program storage/memory 1704 may also be used to store data, such as the various configuration settings 1716 in accordance with the present invention. In one embodiment of the invention, the modules and data are stored in non-volatile electrically-erasable, programmable ROM (EEPROM), flash ROM, etc. so that the information is not lost upon power down of the mobile terminal 1700.

The processor 1702 is also coupled to user interface 1720 elements associated with the mobile terminal. The user interface 1720 of the mobile terminal may include, for example, a display 1722 such as a liquid crystal display, a keypad 1724, speaker 1726, and microphone 1728. These and other user interface components are coupled to the processor 1702 as is known in the art. The keypad 1724 includes alpha-numeric keys for performing a variety of functions, including dialing numbers and executing operations assigned to one or more keys. For example, in accordance with the present invention, the functions associated with the smart browser and associated features may be initiated, configured, etc. via the keypad 1724. Further, the keypad and other user interface 1720 mechanisms may be used to changes modes, select rules and features, etc. in accordance with the present invention. Alternatively, other user interface mechanisms may be employed, such as voice commands, switches, touch pad/screen, graphical user interface using a pointing device, trackball, joystick, or any other user interface mechanism.

The mobile computing arrangement 1700 may also include a digital signal processor (DSP) 1730. The DSP 1730 may perform a variety of functions, including analog-to-digital (A/D) conversion, digital-to-analog (D/A) conversion, speech coding/decoding, encryption/decryption, error detection and correction, bit stream translation, filtering, etc. The transceiver 1732, generally coupled to an antenna 1734, transmits and receives the radio signals associated with the wireless device.

The mobile computing arrangement 1700 of FIG. 17 is provided as a representative example of a computing environment in which the principles of the present invention may be applied. From the description provided herein, those skilled in the art will appreciate that the present invention is equally applicable in a variety of other currently known and future mobile computing environments. For example, the smart browser and associated features in accordance with the present invention may be stored in a variety of manners, may be operable on a variety of processing devices, and may be operable in mobile devices having additional, fewer, or different supporting circuitry and user interface mechanisms.

It is noted that the principles of the present invention are equally applicable to non-mobile terminals, i.e., landline computing systems. Landline computing systems may have different monitor/display sizes, resolutions, and rendering capabilities, and can thus suffer similar rendering inadequacies as those described in connection with mobile devices. Therefore, while much of the present description is described in connection with wireless/mobile terminals, the smart browser and related browser operations are equally applicable to landline computing systems.

Using the description provided herein, the invention may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the invention. As such, the terms “article of manufacture” and “computer program product” as used herein are intended to encompass a computer program that exists permanently or temporarily on any computer-usable medium or in any transmitting medium which transmits such a program..

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links.

From the description provided herein, those skilled in the art are readily able to combine software created as described with appropriate general purpose or special purpose computer hardware to create a mobile computer system and/or computer subcomponents embodying the invention, and to create a mobile computer system and/or computer subcomponents for carrying out the method of the invention.

The foregoing description of the exemplary embodiment of the invention has been presented for the purposes of illustration and description. It is not intended to be exhaustive or to limit the invention to the precise form disclosed. Many modifications and variations are possible in light of the above teaching. For example the present invention may be used to render content provided via any source, and not just Internet content. Further, the principles of the present invention are equally applicable to non-mobile terminals, i.e., landline computing systems. It is intended that the scope of the invention not be limited with these illustrated embodiments, but rather the scope of the invention may be ascertained from the claims appended hereto.

What is claimed is:

1. A method for rendering content on electronic devices having a display, comprising:
receiving content having first format characteristics at an electronic device;
invoking one or more rendering rules based on the particular first format characteristics of the received content;
rendering the content according to the invoked rules, wherein the resulting rendered content has second format characteristics; and
displaying the content as rendered on the display of the electronic device.

2. The method of claim 1, further comprising providing a plurality of selectable rendering modes, wherein each of the selectable rendering modes is associated with a different set of the rendering rules.

3. The method of claim 2, further comprising activating one or more rendering rules to establish the set of rendering rules corresponding to one of the selectable rendering modes.

4. The method of claim 2, wherein the plurality of selectable rendering modes comprises one or more user-definable rendering modes.

5. The method of claim 4, further comprising defining the user-definable rendering mode at the electronic device.

6. The method of claim 4, further comprising receiving the user-definable rendering mode from a content provider, and storing the user-definable rendering mode on the electronic device for selection by the user.

7. The method of claim 2, wherein the plurality of selectable rendering modes comprises one or more pre-defined default rendering modes.

8. The method of claim 7, wherein one of the pre-defined default rendering modes comprises a normal rendering mode wherein the one or more rendering rules associated with the normal rendering mode cause the content to be rendered as closely to the first format characteristics as the display will allow.

9. The method of claim 7, wherein one of the pre-defined default rendering modes comprises a smart rendering mode wherein the one or more rendering rules associated with the normal rendering mode cause the content to be rendered in a manner corresponding to display characteristics of the display.

10. The method of claim 7, further comprising receiving the pre-defined default rendering mode from a content provider, and storing the pre-defined default rendering mode on the electronic device.

11. The method of claim 2, further comprising facilitating user selection of any of the selectable rendering modes.

12. The method of claim 2, further comprising:
associating a bookmarked addresses with one of the selectable rendering modes;
selecting the bookmarked address to launch the content available via the bookmarked address; and
rendering the content according to the selectable rendering mode associated with the bookmarked address.

13. The method of claim 12, further comprising automatically identifying second bookmarked addresses having characteristics corresponding to at least one previously bookmarked address, and associating one or more of the second bookmarked addresses with the selectable rendering mode associated with the previously bookmarked address.

14. The method of claim 1, wherein invoking one or more rendering rules comprises invoking a plurality of rendering rules; and wherein rendering the content comprises rendering the content according to a collective directive of the plurality of rendering rules.

15. The method of claim 1, wherein a plurality of the rendering rules are arranged as a feature for selection by the user, wherein the feature is presented to the user to select attributes for one or more of the rendering rules associated with the feature.

16. The method of claim 15, wherein the feature comprises one or more of the rendering rules that define manners of rendering content links having the first format characteristics to content links having the second format characteristics.

17. The method of claim 16, wherein the second format characteristics comprise at least one of larger content link sizes and different link text than the first format characteristics.

18. The method of claim 1, further comprising:
associating a bookmarked address with one or more of the rendering rules;
selecting the bookmarked address to launch the content available via the bookmarked address; and
rendering the content according to the rendering rules associated with the bookmarked address.

19. The method of claim 18, further comprising automatically identifying second bookmarked addresses having characteristics corresponding to at least one previously bookmarked address, and associating one or more of the second bookmarked addresses with the one or more of the rendering rules associated with the previously bookmarked address.

20. The method of claim 1, wherein rendering the content according to the invoked rules comprises rendering links associated with the content having the first format characteristics to links associated with the content having the second format characteristics.

21. The method of claim 20, wherein the second format characteristics comprise larger content link sizes than the first format characteristics.

22. The method of claim 20, wherein the second format characteristics comprise different link text than the first format characteristics.

23. The method of claim 20, further comprising automatically rendering links associated with the content having the first format characteristics to links having the second format characteristics, wherein a decision to automatically render the links based on at least one of the first format characteristics.

24. The method of claim 23, wherein the first format characteristics comprise at least one of a bitmap size, a bitmap pixel count, a bitmap file size, and a bitmap color count.

25. The method of claim 1, further comprising emphasizing one or more elements associated with the rendered content when displayed on the display of the electronic device.

26. The method of claim 25, further comprising facilitating user-designation of the one or more elements as elements to be emphasized.

27. The method of claim 25, wherein the elements associated with the rendered content comprise at least one of images, frames, banners, tables, and links.

28. The method of claim 25, wherein emphasizing the one or more elements comprises applying a highlight color to the elements.

29. The method of claim 25, further comprising applying one or more of the rendering rules to the one or more emphasized elements upon their selection.

30. The method of claim 29, wherein applying one or more of the rendering rules to the one or more emphasized elements upon their selection comprises displaying the one or more emphasized and selected elements in their original size corresponding to the first format characteristics.

31. The method of claim 29, wherein applying one or more of the rendering rules to the one or more emphasized elements upon their selection comprises hiding the one or more emphasized and selected element, and displaying a remaining portion of the rendered content on the display of the electronic device.

32. The method of claim 29, wherein applying one or more of the rendering rules to the one or more emphasized elements upon their selection comprises hiding the one or more emphasized and selected element, and displaying a remaining portion of the rendered content and a placeholder for the hidden elements on the display of the electronic device.

33. The method of claim 29, wherein applying one or more of the rendering rules to the one or more emphasized elements upon their selection comprises displaying the one or more emphasized and selected elements as at least one of thumbnail elements and textual links.

34. The method of claim 29, wherein applying one or more of the rendering rules to the one or more emphasized elements upon their selection comprises displaying the one or more emphasized and selected elements in a new window on the display of the electronic device.

35. The method of claim 29, wherein applying one or more of the rendering rules to the one or more emphasized elements upon their selection comprises terminating loading of the emphasized and selected elements as the emphasized and selected elements are loading.

36. The method of claim 1, wherein the received content comprises at least one table having a plurality of rows and columns, and wherein rendering the content according to the invoked rules comprises selectively parsing the table row-by-column or column-by-row.

37. The method of claim 36, wherein selectively parsing comprises facilitating user selection of whether the table is to be parsed row-by-column or column-by-row.

38. The method of claim 36, wherein selectively parsing comprises automatically selecting parsing either row-by-column or column-by-row based on one or more predetermined parameters.

39. The method of claim 38, wherein the predetermined parameters comprise at least one of a user's designated preference, a width of the table, a length of the table, a relative width versus length of the table, a number of columns of the table, a number of rows of the table, and a relative number of rows versus columns of the table.

40. The method of claim 1, further comprising activating one or more of the rendering rules, and wherein invoking one or more predefined rendering rules comprises invoking one or more of the rendering rules that have been activated.

41. The method of claim 1, further comprising displaying one or more selectable options via the rendered content on the display of the electronic device, and invoking one or more additional rendering rules based on user selection of the one or more selectable options.

42. An electronic apparatus for presenting content received via a network, comprising:
a memory to store a plurality of rendering rules;
a processor coupled to the memory to receive the rendering rules, wherein the processor is configured to invoke one or more of the rendering rules based on first format characteristics of the received content, and to render the content according to the invoked rules to provide rendered content having second format characteristics; and
a display device to display the rendered content.

43. The electronic apparatus as in claim 42, wherein:
the memory further stores one or more selectable rendering modes, wherein each of the selectable rendering modes is associated with a different set of the rendering rules; and
wherein the processor is further configured to invoke the set of rendering rules associated with a selected one of the selectable rendering modes.

44. The electronic apparatus as in claim 43, further comprising a user interface to facilitate user selection of the selectable rendering modes.

45. The electronic apparatus as in claim 42, wherein the plurality of the rendering rules are arranged as a feature for selection by the user, and further comprising a user interface to facilitate user selection of attributes for one or more of the rendering rules associated with the feature.

46. The electronic apparatus as in claim 42, wherein the processor is further configured to associate a bookmarked address with one or more of the rendering rules, and to render the content according to the rendering rules associated with the bookmarked address upon user selection of the bookmarked address.

47. The electronic apparatus as in claim 46, wherein the processor is further configured to automatically identify second bookmarked addresses having characteristics corresponding to at least one previously bookmarked address, and to associate one or more of the second bookmarked addresses with the one or more of the rendering rules associated with the previously bookmarked address.

48. The electronic apparatus as in claim 42, wherein the processor is further configured to render links associated with the content having the first format characteristics to links associated with the content having the second format characteristics.

49. The electronic apparatus as in claim 48, wherein the second format characteristics comprise at least one of larger visual content links and different link text than the first format characteristics.

50. The electronic apparatus as in claim 48, wherein the processor is further configured to automatically render links associated with the content having the first format characteristics to links having the second format characteristics, and to determine whether the automatic rendering of the links is to occur based on at least one of the first format characteristics.

51. The electronic apparatus as in claim 42, wherein the processor is further configured to emphasize one or more elements associated with the rendered content when displayed on the display of the electronic device.

52. The electronic apparatus as in claim 51, wherein the processor is further configured to apply one or more of the rendering rules to the one or more emphasized elements upon their selection by a user.

53. The electronic apparatus as in claim 42, wherein the received content comprises at least one table having a plurality of rows and columns, and wherein the processor is further configured to render the content by parsing the table either row-by-column or column-by-row depending on the invoked rules.

54. The electronic apparatus as in claim 53, further comprising a user interface to facilitate user selection of whether the table is to be parsed row-by-column or column-by-row.

55. The electronic apparatus as in claim 53, wherein the processor is further configured to automatically select parsing either row-by-column or column-by-row based on one or more predetermined parameters.

56. The electronic apparatus as in claim 42, wherein the electronic apparatus comprises at least one of a wireline computing device, a wireless computing device, and a wireless communication device.

57. A system for transmitting electronic content via a network for viewing by electronic device users, comprising:
(a) a source computing system for transmitting the content via the network, wherein the transmitted content has first format characteristics associated therewith; and
(b) an electronic device coupled to receive the transmitted content from the source computing system via the network, the electronic device comprising:
(1) a memory to store a plurality of rendering rules;
(2) a processor coupled to the memory to receive the rendering rules, wherein the processor is configured to invoke one or more of the rendering rules based on the first format characteristics of the transmitted content, and to render the transmitted content according to the invoked rules to provide rendered content having second format characteristics; and
(3) a display device to display the rendered content.

58. The system as in claim 57, wherein the network comprises one or more of a landline network and a wireless network.

59. The system as in claim 57, wherein the electronic device comprises at least one of a wireline computing device, a wireless computing device, and a wireless communication device.

60. The system as in claim 59, wherein the wireless communication device comprises a wireless telephone.

61. The system as in claim 59, wherein the wireless communication device comprises a personal digital assistant (PDA).

62. A computer-readable medium having instructions stored thereon and executable by a computing arrangement in an electronic device for rendering content on electronic devices having a display by performing steps comprising:
receiving content having first format characteristics at an electronic device;
invoking one or more rendering rules based on the particular first format characteristics of the received content;
rendering the content according to the invoked rules, wherein the resulting rendered content has second format characteristics; and
displaying the content as rendered on the display of the electronic device.
